(19) United States
(12) Patent Application Publication
(10) Pub. No.: US 2026/0205801 A1
(43) Pub. Date: Jul. 16, 2026

(54) APPARATUS, METHOD, AND COMPUTER PROGRAM

(71) Applicant: Nokia Solutions and Networks Oy, Espoo (FI)

(72) Inventors: Lei SU, Beijing (CN); Maximilian RIEGEL, Munich (DE)

(21) Appl. No.: 19/131,262

(22) PCT Filed: Jan. 6, 2023
(86) PCT No.: PCT/CN2023/071115

§ 371 Date: May 20, 2025

(51) Int. Cl. H04W 12/033; H04W 12/0431; H04W 36/08

(52) U.S. Cl. CPC H04W 12/033; H04W 12/0431; H04W 36/08

(57) ABSTRACT

There is provided a method, apparatus, and computer program for causing an apparatus for a source interworking function interfacing between a source access point and a core network, to perform: receiving, an indication that a user equipment is to be handed over from the source access point to a target access point; making a first determination that determines whether the source interworking function interfaces between the target access point and the core network; and determining, in dependence on said first determination, keying material for use in encrypting communications between the target access point and the user equipment.

### FIELD OF THE DISCLOSURE

The examples described herein generally relate to apparatus, methods, and computer programs, and more particularly (but not exclusively) to apparatus, methods and computer programs for apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by the 3rd Generation Partnership Project (3GPP), satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards. 3GPP has issued a number of releases (Rel) for defining operating communication protocols related to a communications network. Currently, objectives and work are being set in relation to Release 18 (Rel. 18).

### SUMMARY

According to a first aspect, there is provided a method for a source interworking function interfacing between a source access point and a core network, the method comprising: receiving, an indication that a user equipment is to be handed over from the source access point to a target access point; making a first determination that determines whether the source interworking function interfaces between the target access point and the core network; and determining, in dependence on said first determination, keying material for use in encrypting communications between the target access point and the user equipment.

The first determination may determine that the source interworking function interfaces between the target access point and the core network, and the determining keying material may comprise: identifying a primary pairwise master key used to derive a source secondary pairwise master key for encrypting communications between the source access point and the user equipment; and using the primary pairwise master key to derive a target secondary pairwise master key for encrypting communications between the target access point and the user equipment.

The first determination may determine that the source interworking function does not interface between the target access point and the core network, and the determining keying material may comprise: identifying a primary pairwise master key used to derive a source secondary pairwise master key for encrypting communications between the source access point and the user equipment; identifying a target interworking function that interfaces between the target access point and the core network; and providing the primary pairwise master key to the target interworking function.

The indication may be received from the source access point in a request for a fast handover, the request for the fast handover comprising a first query, and the method may comprise: providing the first query to the target interworking function; receiving, from the target interworking function, a first response to the first query; and forwarding the first response to the source access point.

The providing the primary pairwise key to the target interworking function may comprise providing the primary pairwise key as part of a first fast transition information element comprised in an Xn user equipment context forward service operation, and wherein the receiving the first response to the first query may comprise receiving a second fast transition information element comprised in an Xn user equipment context forward service operation.

The first determination may determine that the source interworking function does not interface between the target access point and the core network, and the determining keying material may comprise: identifying a primary pairwise master key used to derive a source secondary pairwise master key for encrypting communications between the source access point and the user equipment; and providing the primary pairwise master key to an access and mobility function in the core network.

The indication may be received from the source access point in a request for a fast handover, the request for the fast handover comprising a first query, and the method may comprise: providing the first query to the access and mobility function; receiving, from the access and mobility function, a first response to the first query; and forwarding the first response to the source access point.

The providing the primary pairwise key to the access and mobility function may comprise providing the primary pairwise key as part of a first fast transition information element comprised in an N2 handover required service operation, and wherein the receiving the first response to the first query may comprise receiving a second fast transition information element comprised in an N2 handover command service operation.

The method may comprise, subsequent to the user equipment being handed over from the source access point to the target access point: receiving an instruction to remove the primary pairwise master key; and removing the primary pairwise master key from local storage.

The instruction to remove the primary pairwise master key may be comprised in a user equipment context release message, and the method may comprise: disabling an Internet Protocol Security endpoint for the user equipment in response to receiving said instruction to remove the primary pairwise master key.

According to a second aspect, there is provided a method for a target interworking function interfacing between a target access point and a core network, the method comprising: receiving, an indication that a user equipment is to be handed over from a source access point to the target access point; obtaining keying material comprising a primary pairwise master key that was used to derive a source secondary pairwise master key for encrypting communications between the source access point and the user equipment; using the primary pairwise master key to derive a target secondary pairwise master key for encrypting communications between the target access point and the user equipment; and causing the target secondary pairwise master key to be provided to the target access point.

The indication may be received from a target access point, and wherein the obtaining the primary pairwise master key may comprise: making a first determination that determines that the target interworking function is also a source interworking function that interfaces between the source access point and the core network; and identifying the primary pairwise master key as a key previously used by the target interworking function to derive a source secondary pairwise master key for encrypting communications between the source access point and the user equipment.

The indication may be received from a target access point, and wherein the obtaining the primary pairwise master key may comprise: making a first determination that determines that the target interworking function does not interface between the source access point and the core network; identifying a source interworking function that interfaces between the source access point and the core network; signalling a request for the primary pairwise master key as to at least one of an access and mobility function associated with the core network; and receiving the primary pairwise master key in response to said request.

The indication may be received from the target access point in a request for a fast handover, the request for the fast handover comprising a first query, and the method may comprise: providing the target secondary pairwise master key to the target access point as a response to receiving the indication.

The receiving the primary pairwise key from the source interworking function may comprise receiving the primary pairwise key as part of a first fast transition information element comprised in an Xn user equipment context service operation.

The indication may be received from at least one of an access and mobility function associated with a core network and a source interworking function that interfaces between the source access point and the core network, and wherein the obtaining the primary pairwise master key may comprise: receiving the primary pairwise master key with said indication.

The indication may be comprised in a handover request for handing over the user equipment from the source access point to the target access point.

The indication may be comprised in a user equipment context message.

The method may comprise, subsequent to the user equipment being handed over from the source access point to the target access point, signalling an instruction to a source interworking function that interfaces between the source access point and the core network to remove the primary pairwise master key from the source interworking function.

The method may comprise, subsequent to causing the target secondary pairwise master key to be provided to the target access point, causing an Internet Protocol Security endpoint to be established for traffic of the user equipment.

According to a third aspect, there is provided a method for an access and mobility function associated with a core network, the method comprising: receiving, from a source interworking function that interfaces between a source access point and the core network, keying material comprising a primary pairwise master key that was used to derive a source secondary pairwise master key for encrypting communications between a source access point and the user equipment; and providing the keying material to a target interworking function that interfaces between a target access point and the core network.

The method may comprise receiving, from the target interworking function, a request for the keying material; signalling the request for the keying material to the source interworking function; and receiving the keying material in response to said signalling.

According to a fourth aspect, there is provided a method for an access point, the method comprising: providing, to an interworking function interfacing between the access point and a core network, a request for a fast transition to be performed in respect of a user equipment to be handed over from or to the access point, the request comprising a first fast transition information element relating to a primary keying material; receiving, from the interworking function, a response to said request, the response comprising a second fast transition information element relating to secondary keying material derived from the primary keying material; and providing the second fast transition information element to the user equipment as part of a fast transition procedure.

The method may comprise: completing the fast transition procedure with the user equipment; and signalling, to the interworking function, an indication that the fast transition procedure has been successfully completed, the indication comprising respective identifiers of the user equipment and the access point.

According to a fifth aspect, there is provided a method for a target access point, the method comprising: receiving, from an interworking function interfacing between the target access point and a core network, a request indicating that a user equipment is to be handed over from a source access point to the target access point using a fast transition procedure, the request comprising a first fast transition information element and secondary keying material; using the secondary keying material and the first fast transition information to generate a second fast transition information element that functions as a response to the first fast transition information element for enabling the fast transition procedure to proceed; and signalling the second fast transition element to the interworking function.

The method may comprise: completing the fast transition procedure with the user equipment; and signalling, to the interworking function, an indication that the fast transition procedure has been successfully completed, the indication comprising respective identifiers of the user equipment and the access point.

According to a sixth aspect, there is provided an apparatus for a source interworking function interfacing between a source access point and a core network, the apparatus comprising means for: receiving, an indication that a user equipment is to be handed over from the source access point to a target access point; making a first determination that determines whether the source interworking function interfaces between the target access point and the core network; and determining, in dependence on said first determination, keying material for use in encrypting communications between the target access point and the user equipment.

The first determination may determine that the source interworking function interfaces between the target access point and the core network, and the means for determining keying material may comprise means for: identifying a primary pairwise master key used to derive a source secondary pairwise master key for encrypting communications between the source access point and the user equipment; and using the primary pairwise master key to derive a target secondary pairwise master key for encrypting communications between the target access point and the user equipment.

The first determination may determine that the source interworking function does not interface between the target access point and the core network, and the means for determining keying material may comprise means for: identifying a primary pairwise master key used to derive a source secondary pairwise master key for encrypting communications between the source access point and the user equipment; identifying a target interworking function that interfaces between the target access point and the core network; and providing the primary pairwise master key to the target interworking function.

The indication may be received from the source access point in a request for a fast handover, the request for the fast handover comprising a first query, and the apparatus may comprise means for: providing the first query to the target interworking function; receiving, from the target interworking function, a first response to the first query; and forwarding the first response to the source access point.

The means for providing the primary pairwise key to the target interworking function may comprise means for providing the primary pairwise key as part of a first fast transition information element comprised in an Xn user equipment context forward service operation, and wherein the means for receiving the first response to the first query may comprise means for receiving a second fast transition information element comprised in an Xn user equipment context forward service operation.

The first determination may determine that the source interworking function does not interface between the target access point and the core network, and the means for determining keying material may comprise means for: identifying a primary pairwise master key used to derive a source secondary pairwise master key for encrypting communications between the source access point and the user equipment; and providing the primary pairwise master key to an access and mobility function in the core network.

The indication may be received from the source access point in a request for a fast handover, the request for the fast handover comprising a first query, and the apparatus may comprise means for: providing the first query to the access and mobility function; receiving, from the access and mobility function, a first response to the first query; and forwarding the first response to the source access point.

The means for providing the primary pairwise key to the access and mobility function may comprise means for providing the primary pairwise key as part of a first fast transition information element comprised in an N2 handover required service operation, and wherein the means for receiving the first response to the first query may comprise means for receiving a second fast transition information element comprised in an N2 handover command service operation.

The apparatus may comprise means for, subsequent to the user equipment being handed over from the source access point to the target access point: receiving an instruction to remove the primary pairwise master key; and removing the primary pairwise master key from local storage.

The instruction to remove the primary pairwise master key may be comprised in a user equipment context release message, and the apparatus may comprise means for: disabling an Internet Protocol Security endpoint for the user equipment in response to receiving said instruction to remove the primary pairwise master key.

According to a seventh aspect, there is provided an apparatus for a target interworking function interfacing between a target access point and a core network, the apparatus comprising means for: receiving, an indication that a user equipment is to be handed over from a source access point to the target access point; obtaining keying material comprising a primary pairwise master key that was used to derive a source secondary pairwise master key for encrypting communications between the source access point and the user equipment; using the primary pairwise master key to derive a target secondary pairwise master key for encrypting communications between the target access point and the user equipment; and causing the target secondary pairwise master key to be provided to the target access point.

The indication may be received from a target access point, and wherein the means for obtaining the primary pairwise master key may comprise means for: making a first determination that determines that the target interworking function is also a source interworking function that interfaces between the source access point and the core network; and identifying the primary pairwise master key as a key previously used by the target interworking function to derive a source secondary pairwise master key for encrypting communications between the source access point and the user equipment.

The indication may be received from a target access point, and wherein the means for obtaining the primary pairwise master key may comprise means for: making a first determination that determines that the target interworking function does not interface between the source access point and the core network; identifying a source interworking function that interfaces between the source access point and the core network; signalling a request for the primary pairwise master key as to at least one of an access and mobility function associated with the core network; and receiving the primary pairwise master key in response to said request.

The indication may be received from the target access point in a request for a fast handover, the request for the fast handover comprising a first query, and the apparatus may comprise means for: providing the target secondary pairwise master key to the target access point as a response to receiving the indication.

The means for receiving the primary pairwise key from the source interworking function may comprise means for receiving the primary pairwise key as part of a first fast transition information element comprised in an Xn user equipment context service operation.

The indication may be received from at least one of an access and mobility function associated with a core network and a source interworking function that interfaces between the source access point and the core network, and wherein the means for obtaining the primary pairwise master key may comprise means for: receiving the primary pairwise master key with said indication.

The indication may be comprised in a handover request for handing over the user equipment from the source access point to the target access point.

The indication may be comprised in a user equipment context message.

The apparatus may comprise means for, subsequent to the user equipment being handed over from the source access point to the target access point, signalling an instruction to a source interworking function that interfaces between the source access point and the core network to remove the primary pairwise master key from the source interworking function.

The apparatus may comprise means for, subsequent to causing the target secondary pairwise master key to be provided to the target access point, causing an Internet Protocol Security endpoint to be established for traffic of the user equipment.

According to an eighth aspect, there is provided an apparatus for an access and mobility function associated with a core network, the apparatus comprising means for: receiving, from a source interworking function that interfaces between a source access point and the core network, keying material comprising a primary pairwise master key that was used to derive a source secondary pairwise master key for encrypting communications between a source access point and the user equipment; and providing the keying material to a target interworking function that interfaces between a target access point and the core network.

The apparatus may comprise means for receiving, from the target interworking function, a request for the keying material; signalling the request for the keying material to the source interworking function; and receiving the keying material in response to said signalling.

According to a ninth aspect, there is provided an apparatus for an access point, the apparatus comprising means for: providing, to an interworking function interfacing between the access point and a core network, a request for a fast transition to be performed in respect of a user equipment to be handed over from or to the access point, the request comprising a first fast transition information element relating to a primary keying material; receiving, from the interworking function, a response to said request, the response comprising a second fast transition information element relating to secondary keying material derived from the primary keying material; and providing the second fast transition information element to the user equipment as part of a fast transition procedure.

The apparatus may comprise means for: completing the fast transition procedure with the user equipment; and signalling, to the interworking function, an indication that the fast transition procedure has been successfully completed, the indication comprising respective identifiers of the user equipment and the access point.

According to a tenth aspect, there is provided an apparatus for a target access point, the apparatus comprising means for: receiving, from an interworking function interfacing between the target access point and a core network, a request indicating that a user equipment is to be handed over from a source access point to the target access point using a fast transition procedure, the request comprising a first fast transition information element and secondary keying material; using the secondary keying material and the first fast transition information to generate a second fast transition information element that functions as a response to the first fast transition information element for enabling the fast transition procedure to proceed; and signalling the second fast transition element to the interworking function.

The apparatus may comprise means for: completing the fast transition procedure with the user equipment; and signalling, to the interworking function, an indication that the fast transition procedure has been successfully completed, the indication comprising respective identifiers of the user equipment and the access point.

According to an eleventh aspect, there is provided an apparatus for a source interworking function interfacing between a source access point and a core network, the apparatus comprising: at least one processor; and at least one memory comprising code that, when executed by the at least one processor, causes the apparatus to perform: receiving, an indication that a user equipment is to be handed over from the source access point to a target access point; making a first determination that determines whether the source interworking function interfaces between the target access point and the core network; and determining, in dependence on said first determination, keying material for use in encrypting communications between the target access point and the user equipment.

The first determination may determine that the source interworking function interfaces between the target access point and the core network, and the determining keying material may comprise: identifying a primary pairwise master key used to derive a source secondary pairwise master key for encrypting communications between the source access point and the user equipment; and using the primary pairwise master key to derive a target secondary pairwise master key for encrypting communications between the target access point and the user equipment.

The first determination may determine that the source interworking function does not interface between the target access point and the core network, and the determining keying material may comprise: identifying a primary pairwise master key used to derive a source secondary pairwise master key for encrypting communications between the source access point and the user equipment; identifying a target interworking function that interfaces between the target access point and the core network; and providing the primary pairwise master key to the target interworking function.

The indication may be received from the source access point in a request for a fast handover, the request for the fast handover comprising a first query, and the apparatus may be caused to perform: providing the first query to the target interworking function; receiving, from the target interworking function, a first response to the first query; and forwarding the first response to the source access point.

The providing the primary pairwise key to the target interworking function may comprise providing the primary pairwise key as part of a first fast transition information element comprised in an Xn user equipment context forward service operation, and wherein the receiving the first response to the first query may comprise receiving a second fast transition information element comprised in an Xn user equipment context forward service operation.

The first determination may determine that the source interworking function does not interface between the target access point and the core network, and the determining keying material may comprise: identifying a primary pairwise master key used to derive a source secondary pairwise master key for encrypting communications between the source access point and the user equipment; and providing the primary pairwise master key to an access and mobility function in the core network.

The indication may be received from the source access point in a request for a fast handover, the request for the fast handover comprising a first query, and the apparatus may be caused to perform: providing the first query to the access and mobility function; receiving, from the access and mobility function, a first response to the first query; and forwarding the first response to the source access point.

The providing the primary pairwise key to the access and mobility function may comprise providing the primary pairwise key as part of a first fast transition information element comprised in an N2 handover required service operation, and wherein the receiving the first response to the first query may comprise receiving a second fast transition information element comprised in an N2 handover command service operation.

The apparatus may be caused to perform, subsequent to the user equipment being handed over from the source access point to the target access point: receiving an instruction to remove the primary pairwise master key; and removing the primary pairwise master key from local storage.

The instruction to remove the primary pairwise master key may be comprised in a user equipment context release message, and the apparatus may be caused to perform: disabling an Internet Protocol Security endpoint for the user equipment in response to receiving said instruction to remove the primary pairwise master key.

According to a twelfth aspect, there is provided an apparatus for a target interworking function interfacing between a target access point and a core network, the apparatus comprising: at least one processor; and at least one memory comprising code that, when executed by the at least one processor, causes the apparatus to perform: receiving, an indication that a user equipment is to be handed over from a source access point to the target access point; obtaining keying material comprising a primary pairwise master key that was used to derive a source secondary pairwise master key for encrypting communications between the source access point and the user equipment; using the primary pairwise master key to derive a target secondary pairwise master key for encrypting communications between the target access point and the user equipment; and causing the target secondary pairwise master key to be provided to the target access point.

The indication may be received from a target access point, and wherein the obtaining the primary pairwise master key may comprise: making a first determination that determines that the target interworking function is also a source interworking function that interfaces between the source access point and the core network; and identifying the primary pairwise master key as a key previously used by the target interworking function to derive a source secondary pairwise master key for encrypting communications between the source access point and the user equipment.

The indication may be received from a target access point, and wherein the obtaining the primary pairwise master key may comprise: making a first determination that determines that the target interworking function does not interface between the source access point and the core network; identifying a source interworking function that interfaces between the source access point and the core network; signalling a request for the primary pairwise master key as to at least one of an access and mobility function associated with the core network; and receiving the primary pairwise master key in response to said request.

The indication may be received from the target access point in a request for a fast handover, the request for the fast handover comprising a first query, and the apparatus may be caused to perform: providing the target secondary pairwise master key to the target access point as a response to receiving the indication.

The receiving the primary pairwise key from the source interworking function may comprise receiving the primary pairwise key as part of a first fast transition information element comprised in an Xn user equipment context service operation.

The indication may be received from at least one of an access and mobility function associated with a core network and a source interworking function that interfaces between the source access point and the core network, and wherein the obtaining the primary pairwise master key may comprise: receiving the primary pairwise master key with said indication.

The indication may be comprised in a handover request for handing over the user equipment from the source access point to the target access point.

The indication may be comprised in a user equipment context message.

The apparatus may be caused to perform, subsequent to the user equipment being handed over from the source access point to the target access point, signalling an instruction to a source interworking function that interfaces between the source access point and the core network to remove the primary pairwise master key from the source interworking function.

The apparatus may be caused to perform, subsequent to causing the target secondary pairwise master key to be provided to the target access point, causing an Internet Protocol Security endpoint to be established for traffic of the user equipment.

According to a thirteenth aspect, there is provided an apparatus for an access and mobility function associated with a core network, the apparatus comprising: at least one processor; and at least one memory comprising code that, when executed by the at least one processor, causes the apparatus to perform: receiving, from a source interworking function that interfaces between a source access point and the core network, keying material comprising a primary pairwise master key that was used to derive a source secondary pairwise master key for encrypting communications between a source access point and the user equipment; and providing the keying material to a target interworking function that interfaces between a target access point and the core network.

The apparatus may be caused to perform receiving, from the target interworking function, a request for the keying material; signalling the request for the keying material to the source interworking function; and receiving the keying material in response to said signalling.

According to a fourteenth aspect, there is provided an apparatus for an access point, the apparatus comprising: at least one processor; and at least one memory comprising code that, when executed by the at least one processor, causes the apparatus to perform: providing, to an interworking function interfacing between the access point and a core network, a request for a fast transition to be performed in respect of a user equipment to be handed over from or to the access point, the request comprising a first fast transition information element relating to a primary keying material; receiving, from the interworking function, a response to said request, the response comprising a second fast transition information element relating to secondary keying material derived from the primary keying material; and providing the second fast transition information element to the user equipment as part of a fast transition procedure.

The apparatus may be caused to perform: completing the fast transition procedure with the user equipment; and signalling, to the interworking function, an indication that the fast transition procedure has been successfully completed, the indication comprising respective identifiers of the user equipment and the access point.

According to a fifteenth aspect, there is provided an apparatus for a target access point, the apparatus comprising: at least one processor; and at least one memory comprising code that, when executed by the at least one processor, causes the apparatus to perform: receiving, from an interworking function interfacing between the target access point and a core network, a request indicating that a user equipment is to be handed over from a source access point to the target access point using a fast transition procedure, the request comprising a first fast transition information element and secondary keying material; using the secondary keying material and the first fast transition information to generate a second fast transition information element that functions as a response to the first fast transition information element for enabling the fast transition procedure to proceed; and signalling the second fast transition element to the interworking function.

The apparatus may be caused to perform: completing the fast transition procedure with the user equipment; and signalling, to the interworking function, an indication that the fast transition procedure has been successfully completed, the indication comprising respective identifiers of the user equipment and the access point.

According to a sixteenth aspect, there is provided an apparatus for a source interworking function interfacing between a source access point and a core network, the apparatus comprising: receiving circuitry for receiving, an indication that a user equipment is to be handed over from the source access point to a target access point; determining circuitry for making a first determination that determines whether the source interworking function interfaces between the target access point and the core network; and determining circuitry for determining, in dependence on said first determination, keying material for use in encrypting communications between the target access point and the user equipment.

The first determination may determine that the source interworking function interfaces between the target access point and the core network, and the determining circuitry for determining keying material may comprise: identifying circuitry for identifying a primary pairwise master key used to derive a source secondary pairwise master key for encrypting communications between the source access point and the user equipment; and using circuitry for using the primary pairwise master key to derive a target secondary pairwise master key for encrypting communications between the target access point and the user equipment.

The first determination may determine that the source interworking function does not interface between the target access point and the core network, and the determining circuitry for determining keying material may comprise: identifying circuitry for identifying a primary pairwise master key used to derive a source secondary pairwise master key for encrypting communications between the source access point and the user equipment; identifying circuitry for identifying a target interworking function that interfaces between the target access point and the core network; and providing circuitry for providing the primary pairwise master key to the target interworking function.

The indication may be received from the source access point in a request for a fast handover, the request for the fast handover comprising a first query, and the apparatus may comprise: providing circuitry for providing the first query to the target interworking function; receiving circuitry for receiving, from the target interworking function, a first response to the first query; and forwarding circuitry for forwarding the first response to the source access point.

The providing circuitry for providing the primary pairwise key to the target interworking function may comprise providing circuitry for providing the primary pairwise key as part of a first fast transition information element comprised in an Xn user equipment context forward service operation, and wherein the receiving circuitry for receiving the first response to the first query may comprise receiving circuitry for receiving a second fast transition information element comprised in an Xn user equipment context forward service operation.

The first determination may determine that the source interworking function does not interface between the target access point and the core network, and the determining circuitry for determining keying material may comprise: identifying circuitry for identifying a primary pairwise master key used to derive a source secondary pairwise master key for encrypting communications between the source access point and the user equipment; and providing circuitry for providing the primary pairwise master key to an access and mobility function in the core network.

The indication may be received from the source access point in a request for a fast handover, the request for the fast handover comprising a first query, and the apparatus may comprise: providing circuitry for providing the first query to the access and mobility function; receiving circuitry for receiving, from the access and mobility function, a first response to the first query; and forwarding circuitry for forwarding the first response to the source access point.

The providing circuitry for providing the primary pairwise key to the access and mobility function may comprise providing circuitry for providing the primary pairwise key as part of a first fast transition information element comprised in an N2 handover required service operation, and wherein the receiving circuitry for receiving the first response to the first query may comprise receiving circuitry for receiving a second fast transition information element comprised in an N2 handover command service operation.

The apparatus may comprise, subsequent to the user equipment being handed over from the source access point to the target access point: receiving circuitry for receiving an instruction to remove the primary pairwise master key; and removing circuitry for removing the primary pairwise master key from local storage.

The instruction to remove the primary pairwise master key may be comprised in a user equipment context release message, and the apparatus may comprise: disabling circuitry for disabling an Internet Protocol Security endpoint for the user equipment in response to receiving said instruction to remove the primary pairwise master key.

According to a seventeenth aspect, there is provided an apparatus for a target interworking function interfacing between a target access point and a core network, the apparatus comprising: receiving circuitry for receiving, an indication that a user equipment is to be handed over from a source access point to the target access point; obtaining circuitry for obtaining keying material comprising a primary pairwise master key that was used to derive a source secondary pairwise master key for encrypting communications between the source access point and the user equipment; using circuitry for using the primary pairwise master key to derive a target secondary pairwise master key for encrypting communications between the target access point and the user equipment; and causing circuitry for causing the target secondary pairwise master key to be provided to the target access point.

The indication may be received from a target access point, and wherein the obtaining circuitry for obtaining the primary pairwise master key may comprise: determining circuitry for making a first determination that determines that the target interworking function is also a source interworking function that interfaces between the source access point and the core network; and identifying circuitry for identifying the primary pairwise master key as a key previously used by the target interworking function to derive a source secondary pairwise master key for encrypting communications between the source access point and the user equipment.

The indication may be received from a target access point, and wherein the obtaining circuitry for obtaining the primary pairwise master key may comprise: determining circuitry for making a first determination that determines that the target interworking function does not interface between the source access point and the core network; identifying circuitry for identifying a source interworking function that interfaces between the source access point and the core network; signalling circuitry for signalling a request for the primary pairwise master key as to at least one of an access and mobility function associated with the core network; and receiving circuitry for receiving the primary pairwise master key in response to said request.

The indication may be received from the target access point in a request for a fast handover, the request for the fast handover comprising a first query, and the apparatus may comprise: providing circuitry for providing the target secondary pairwise master key to the target access point as a response to receiving the indication.

The receiving circuitry for receiving the primary pairwise key from the source interworking function may comprise receiving circuitry for receiving the primary pairwise key as part of a first fast transition information element comprised in an Xn user equipment context service operation.

The indication may be received from at least one of an access and mobility function associated with a core network and a source interworking function that interfaces between the source access point and the core network, and wherein the obtaining circuitry for obtaining the primary pairwise master key may comprise: receiving circuitry for receiving the primary pairwise master key with said indication.

The indication may be comprised in a handover request for handing over the user equipment from the source access point to the target access point.

The indication may be comprised in a user equipment context message.

The apparatus may comprise, subsequent to the user equipment being handed over from the source access point to the target access point, signalling circuitry for signalling an instruction to a source interworking function that interfaces between the source access point and the core network to remove the primary pairwise master key from the source interworking function.

The apparatus may comprise, subsequent to causing the target secondary pairwise master key to be provided to the target access point, causing circuitry for causing an Internet Protocol Security endpoint to be established for traffic of the user equipment.

According to an eighteenth aspect, there is provided an apparatus for an access and mobility function associated with a core network, the apparatus comprising: receiving circuitry for receiving, from a source interworking function that interfaces between a source access point and the core network, keying material comprising a primary pairwise master key that was used to derive a source secondary pairwise master key for encrypting communications between a source access point and the user equipment; and providing circuitry for providing the keying material to a target interworking function that interfaces between a target access point and the core network.

The apparatus may comprise: receiving circuitry for receiving, from the target interworking function, a request for the keying material; signalling circuitry for signalling the request for the keying material to the source interworking function; and receiving circuitry for receiving the keying material in response to said signalling.

According to a nineteenth aspect, there is provided an apparatus for an access point, the apparatus comprising: providing circuitry for providing, to an interworking function interfacing between the access point and a core network, a request for a fast transition to be performed in respect of a user equipment to be handed over from or to the access point, the request comprising a first fast transition information element relating to a primary keying material; receiving circuitry for receiving, from the interworking function, a response to said request, the response comprising a second fast transition information element relating to secondary keying material derived from the primary keying material; and providing circuitry for providing the second fast transition information element to the user equipment as part of a fast transition procedure.

The apparatus may comprise: completing circuitry for completing the fast transition procedure with the user equipment; and signalling circuitry for signalling, to the interworking function, an indication that the fast transition procedure has been successfully completed, the indication comprising respective identifiers of the user equipment and the access point.

According to a twentieth aspect, there is provided an apparatus for a target access point, the apparatus comprising: receiving circuitry for receiving, from an interworking function interfacing between the target access point and a core network, a request indicating that a user equipment is to be handed over from a source access point to the target access point using a fast transition procedure, the request comprising a first fast transition information element and secondary keying material; using circuitry for using the secondary keying material and the first fast transition information to generate a second fast transition information element that functions as a response to the first fast transition information element for enabling the fast transition procedure to proceed; and signalling circuitry for signalling the second fast transition element to the interworking function.

The apparatus may comprise: completing circuitry for completing the fast transition procedure with the user equipment; and signalling circuitry for signalling, to the interworking function, an indication that the fast transition procedure has been successfully completed, the indication comprising respective identifiers of the user equipment and the access point.

According to a twenty first aspect, there is provided non-transitory computer readable medium comprising program instructions for causing an apparatus for a source interworking function interfacing between a source access point and a core network to perform: receiving, an indication that a user equipment is to be handed over from the source access point to a target access point; making a first determination that determines whether the source interworking function interfaces between the target access point and the core network; and determining, in dependence on said first determination, keying material for use in encrypting communications between the target access point and the user equipment.

The first determination may determine that the source interworking function interfaces between the target access point and the core network, and the determining keying material may comprise: identifying a primary pairwise master key used to derive a source secondary pairwise master key for encrypting communications between the source access point and the user equipment; and using the primary pairwise master key to derive a target secondary pairwise master key for encrypting communications between the target access point and the user equipment.

The first determination may determine that the source interworking function does not interface between the target access point and the core network, and the determining keying material may comprise: identifying a primary pairwise master key used to derive a source secondary pairwise master key for encrypting communications between the source access point and the user equipment; identifying a target interworking function that interfaces between the target access point and the core network; and providing the primary pairwise master key to the target interworking function.

The indication may be received from the source access point in a request for a fast handover, the request for the fast handover comprising a first query, and the apparatus may be caused to perform: providing the first query to the target interworking function; receiving, from the target interworking function, a first response to the first query; and forwarding the first response to the source access point.

The providing the primary pairwise key to the target interworking function may comprise providing the primary pairwise key as part of a first fast transition information element comprised in an Xn user equipment context forward service operation, and wherein the receiving the first response to the first query may comprise receiving a second fast transition information element comprised in an Xn user equipment context forward service operation.

The first determination may determine that the source interworking function does not interface between the target access point and the core network, and the determining keying material may comprise: identifying a primary pairwise master key used to derive a source secondary pairwise master key for encrypting communications between the source access point and the user equipment; and providing the primary pairwise master key to an access and mobility function in the core network.

The indication may be received from the source access point in a request for a fast handover, the request for the fast handover comprising a first query, and the apparatus may be caused to perform: providing the first query to the access and mobility function; receiving, from the access and mobility function, a first response to the first query; and forwarding the first response to the source access point.

The providing the primary pairwise key to the access and mobility function may comprise providing the primary pairwise key as part of a first fast transition information element comprised in an N2 handover required service operation, and wherein the receiving the first response to the first query may comprise receiving a second fast transition information element comprised in an N2 handover command service operation.

The apparatus may be caused to perform, subsequent to the user equipment being handed over from the source access point to the target access point: receiving an instruction to remove the primary pairwise master key; and removing the primary pairwise master key from local storage.

The instruction to remove the primary pairwise master key may be comprised in a user equipment context release message, and the apparatus may be caused to perform: disabling an Internet Protocol Security endpoint for the user equipment in response to receiving said instruction to remove the primary pairwise master key.

According to a twenty second aspect, there is provided non-transitory computer readable medium comprising program instructions for causing an apparatus for a target interworking function interfacing between a target access point and a core network to perform: receiving, an indication that a user equipment is to be handed over from a source access point to the target access point; obtaining keying material comprising a primary pairwise master key that was used to derive a source secondary pairwise master key for encrypting communications between the source access point and the user equipment; using the primary pairwise master key to derive a target secondary pairwise master key for encrypting communications between the target access point and the user equipment; and causing the target secondary pairwise master key to be provided to the target access point.

The indication may be received from a target access point, and wherein the obtaining the primary pairwise master key may comprise: making a first determination that determines that the target interworking function is also a source interworking function that interfaces between the source access point and the core network; and identifying the primary pairwise master key as a key previously used by the target interworking function to derive a source secondary pairwise master key for encrypting communications between the source access point and the user equipment.

The indication may be received from a target access point, and wherein the obtaining the primary pairwise master key may comprise: making a first determination that determines that the target interworking function does not interface between the source access point and the core network; identifying a source interworking function that interfaces between the source access point and the core network; signalling a request for the primary pairwise master key as to at least one of an access and mobility function associated with the core network; and receiving the primary pairwise master key in response to said request.

The indication may be received from the target access point in a request for a fast handover, the request for the fast handover comprising a first query, and the apparatus may be caused to perform: providing the target secondary pairwise master key to the target access point as a response to receiving the indication.

The receiving the primary pairwise key from the source interworking function may comprise receiving the primary pairwise key as part of a first fast transition information element comprised in an Xn user equipment context service operation.

The indication may be received from at least one of an access and mobility function associated with a core network and a source interworking function that interfaces between the source access point and the core network, and wherein the obtaining the primary pairwise master key may comprise: receiving the primary pairwise master key with said indication.

The indication may be comprised in a handover request for handing over the user equipment from the source access point to the target access point.

The indication may be comprised in a user equipment context message.

The apparatus may be caused to perform, subsequent to the user equipment being handed over from the source access point to the target access point, signalling an instruction to a source interworking function that interfaces between the source access point and the core network to remove the primary pairwise master key from the source interworking function.

The apparatus may be caused to perform, subsequent to causing the target secondary pairwise master key to be provided to the target access point, causing an Internet Protocol Security endpoint to be established for traffic of the user equipment.

According to a twenty third aspect, there is provided non-transitory computer readable medium comprising program instructions for causing an apparatus for an access and mobility function associated with a core network to perform: receiving, from a source interworking function that interfaces between a source access point and the core network, keying material comprising a primary pairwise master key that was used to derive a source secondary pairwise master key for encrypting communications between a source access point and the user equipment; and providing the keying material to a target interworking function that interfaces between a target access point and the core network.

The apparatus may be caused to perform receiving, from the target interworking function, a request for the keying material; signalling the request for the keying material to the source interworking function; and receiving the keying material in response to said signalling.

According to a twenty fourth aspect, there is provided non-transitory computer readable medium comprising program instructions for causing an apparatus for an access point to perform: providing, to an interworking function interfacing between the access point and a core network, a request for a fast transition to be performed in respect of a user equipment to be handed over from or to the access point, the request comprising a first fast transition information element relating to a primary keying material; receiving, from the interworking function, a response to said request, the response comprising a second fast transition information element relating to secondary keying material derived from the primary keying material; and providing the second fast transition information element to the user equipment as part of a fast transition procedure.

The apparatus may be caused to perform: completing the fast transition procedure with the user equipment; and signalling, to the interworking function, an indication that the fast transition procedure has been successfully completed, the indication comprising respective identifiers of the user equipment and the access point.

According to a twenty fifth aspect, there is provided non-transitory computer readable medium comprising program instructions for causing an apparatus for a target access point to perform: receiving, from an interworking function interfacing between the target access point and a core network, a request indicating that a user equipment is to be handed over from a source access point to the target access point using a fast transition procedure, the request comprising a first fast transition information element and secondary keying material; using the secondary keying material and the first fast transition information to generate a second fast transition information element that functions as a response to the first fast transition information element for enabling the fast transition procedure to proceed; and signalling the second fast transition element to the interworking function.

The apparatus may be caused to perform: completing the fast transition procedure with the user equipment; and signalling, to the interworking function, an indication that the fast transition procedure has been successfully completed, the indication comprising respective identifiers of the user equipment and the access point.

According to a twenty sixth aspect, there is provided a computer program product stored on a medium that may cause an apparatus to perform any method as described herein.

According to a twenty seventh aspect, there is provided an electronic device that may comprise apparatus as described herein.

According to a twenty eighth aspect, there is provided a chipset that may comprise an apparatus as described herein.

### BRIEF DESCRIPTION OF FIGURES

Some examples, will now be described, merely by way of illustration only, with reference to the accompanying drawings in which:

FIG. 1 shows a schematic representation of a 5G system;

FIG. 2 shows a schematic representation of a network apparatus;

FIG. 3 shows a schematic representation of a user equipment;

FIG. 4 illustrates a network architecture;

FIG. 5 illustrates an access architecture;

FIG. 6 illustrates example protocol stacks;

FIG. 7 illustrates signalling;

FIG. 8 illustrates an architecture;

FIG. 9 illustrates an example architecture;

FIGS. 10 to 15 illustrate example signalling operations; and

FIGS. 16 to 20 illustrate operations that may be performed by apparatus described herein.

### DETAILED DESCRIPTION

In the following description of examples, certain aspects are explained with reference to devices that are often capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals, IEEE 802.11, etc.).

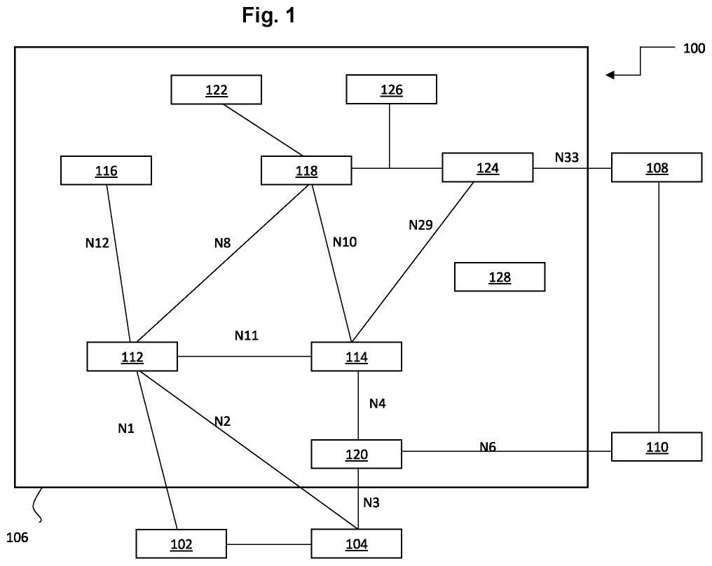

Before describing in detail the examples, certain general principles of a 5G wireless communication system are briefly explained with reference to FIGS. 1 to 3.

FIG. 1 shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

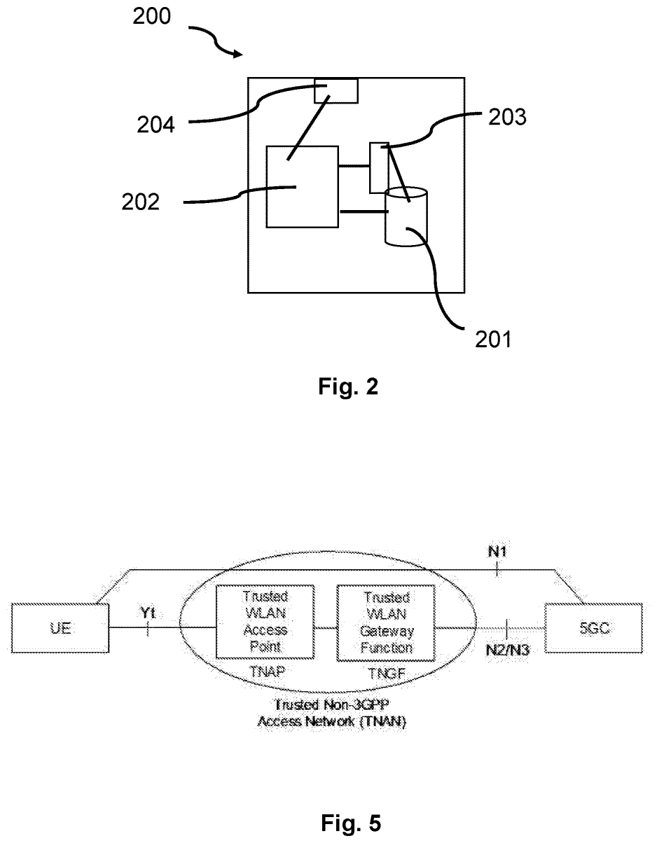

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

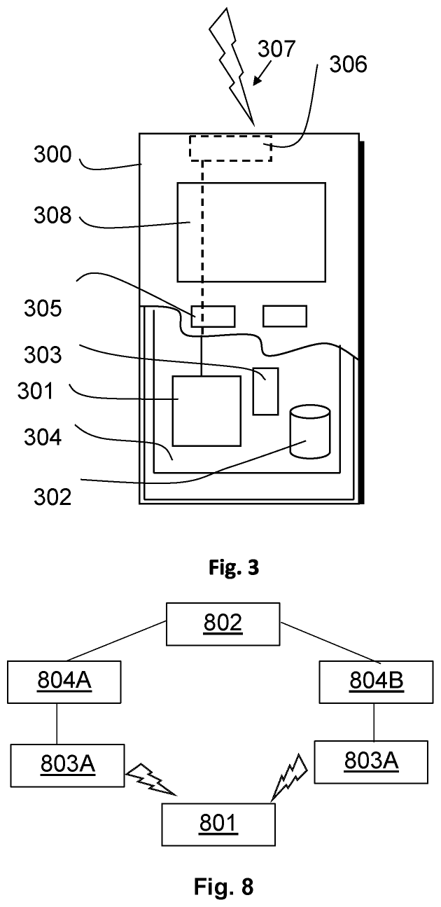

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or′ wireless) to other devices and/or for connecting external accessories, for example hands-free equipment, thereto.

3GPP Release 15 architecture supports access to the 5G system using at least one of 5G NR as well as non-3GPP access networks. Non-3GPP access networks are often untrusted within a 3GPP network. Importantly, the 5GCN has been defined to be access agnostic. This means that both 5G NR and non-3GPP access are interfaced to the 5G Core using the same user plane (N3) and control plane interfaces (N2).

Therefore, to help effect these dual access paths, a Non-3GPP Inter-Working Function (N3IWF) was defined to help facilitate communications between the 3GPP network and the untrusted non-3GPP access. The N3IWF terminates N2 and N3 interfaces extending to or from the 5GC and the non-3GPP access.

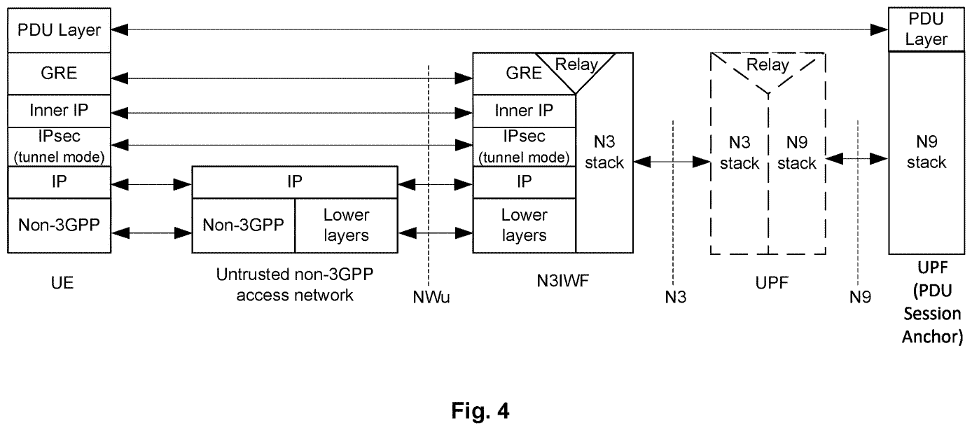

FIG. 4 illustrates the different protocol layers that interface within a network architecture in which an untrusted non-3GPP access network is used to provide a UE with access to a 5GC.

FIG. 4 shows a UE comprising a protocol data unit (PDU) protocol layer, a Generic Routing Encapsulation (GRE) protocol layer, an inner Internet Protocol (IP) layer, an IP security (IPsec) layer, an IP layer, and a non-3GPP layer. GRE is a tunnelling protocol that can encapsulate a number of OSI layer three (i.e. network layer) protocols. The GRE protocol can be used for both point-to-point links (in which two endpoints communicate with each other) and/or for point-to-multipoint links (in which one node can transmit data to many nodes).

The IP and non-3GPP layers of the UE interact with respective IP and non-3GPP layers of an untrusted non-3GPP access network. The IP layer and lower layers of the non-3GPP access network interact with respective IP and lower layers of an N3IWF over an NWu interface.

The GRE, Inner IP and IPsec layers of the UE interact with respective GRE, Inner IP and IPsec layers on the N3IWF over an NWu interface.

The N2IWF, which functions as a relay, interfaces with a user plane function using an N3 protocol stack over an N3 interface.

The user plane function, which also functions as a relay, interacts with a UPF that is acting as a session anchor for the PDU session using an N9 protocol stack over an N9 interface. The PDU layer of the UE also interfaces with a respective PDU layer of the UPF that acting as a session anchor for the PDU session.

3GPP Release 16 made steps towards enabling a non-3GPP access to become a trusted access network by introducing architecture that supported the integration of wireless local area network (WLAN) systems into the 5GS architecture using a “trusted model”.

Under this trusted model, a WLAN access is deployed and managed by either a 5G mobile operator or by a third party who is trusted by the 5G mobile operator. In such a case, the WLAN access is trusted by both the 5G core as well as by the 5G terminals once the WLAN access is registered as being trusted in the 5G system.

A Trusted WLAN Access Network (TNAN) comprises two type of network functions:
1. A Trusted WLAN Access Point (TNAP), which terminates the UE's IEEE 802.11 protocol stacks over the air access link defined in IEEE Standard. 802.11; and
2. A Trusted WLAN Gateway Function (TNGF), which exposes the N2/N3 interfaces and enables the UE to connect to the 5G Core over the WLAN access technology.

This is illustrated with respect to FIG. 5.

FIG. 5 illustrates a UE that interfaces with a 5GC over an N1 interface, and which interfaces with a TNAP of a TNAN over a Yt interface. The TNAN further comprises a TNGF that interfaces with the 5GC over an N₂ interface and/or an N3 interface.

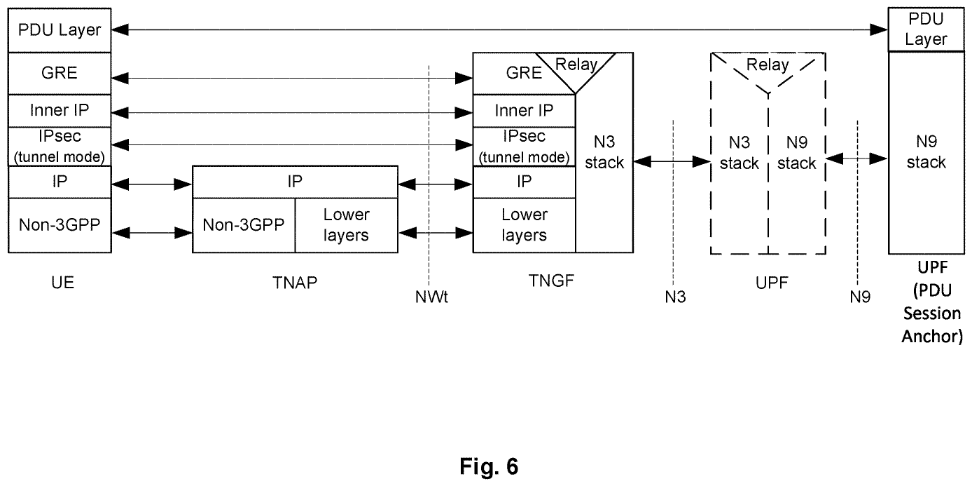

Trusted and Non-trusted non-3GPP access deploy very similar approaches for interfacing with a 5GS. The primary difference between the trusted and non-trusted approaches lies in the trusted non-3GPP allowing for ciphering on the IPsec connection between the TNGF and UE (Y1) to be disabled in the trusted access case, while this disabling is not allowed for the non-trusted access case. Aside of the ciphering decision, all framing and signalling are the same for the trusted as well as the untrusted case. This can be seen by comparing the protocol stacks of FIG. 4 for the untrusted non-3GPP access architecture to the protocol stacks of FIG. 6 for the trusted non-3GPP access architecture.

FIG. 6 illustrates the different protocol layers that interface within a network architecture in which a trusted non-3GPP access network is used to provide a UE with access to a 5GC.

FIG. 6 shows a UE comprising a protocol data unit (PDU) protocol layer, a Generic Routing Encapsulation (GRE) protocol layer, an inner Internet Protocol (IP) layer, an IP security (IPsec) layer, an IP layer, and a non-3GPP layer.

The IP and non-3GPP layers of the UE interact with respective IP and non-3GPP layers of a TNAP. The IP layer and lower layers of the TNAP interact with respective IP and lower layers of a TNGF over an NWt interface.

The GRE, Inner IP and IPsec layers of the UE interact with respective GRE, Inner IP and IPsec layers on the TNGF over an NWt interface.

The TNGF, which functions as a relay, interfaces with a user plane function using an N3 protocol stack over an N3 interface.

The user plane function, which also functions as a relay, interacts with a UPF that is acting as a session anchor for the PDU session using an N9 protocol stack over an N9 interface. The PDU layer of the UE also interfaces with a respective PDU layer of the UPF that acting as a session anchor for the PDU session.

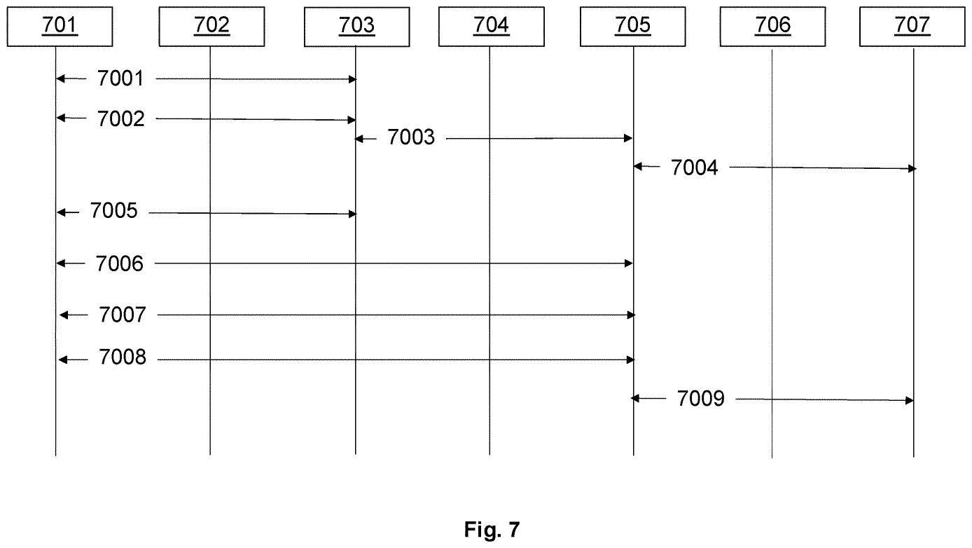

FIG. 7 illustrates how a UE may register with a 5GC over a TNGF. This procedure is currently defined in TS 23.502, which describes how registration procedures over trusted non-3GPP access may be performed during an Xn-based or N2-based handover scenario. (N.B. Xn, in this context, refers to an interface between two access nodes. Therefore, an Xn-based handover refers to handover that comprises signaling over an Xn-interface. Further, N2, in this context, refers to an interface between an access node and an access and mobility function Therefore, an N2-based handover refers to handover that comprises signaling over an N2-interface.)

FIG. 7 illustrates signalling that may be performed between a UE 701, a gNB 702, a source TNAP 703, a target access point 704, a source TNGF 705, a target N3IWF or TNGF 706 and an AMF 705.

During 7001, the UE 701 and source TNAP 703 exchange signalling to establish a layer 2 connection therebetween.

During 7002, the UE 701 and source TNAP 703 exchange signalling for initiating an Extensible Authentication Protocol (EAP) procedure. EAP is a protocol for wireless networks that expands the authentication methods used by the Point-to-Point Protocol (PPP), a protocol often used when connecting a computer to the internet. EAP is used on encrypted networks to provide a secure way to send identifying information to provide network authentication.

During this signalling, a registration request is encapsulated in an EAP message that is encapsulated into layer-2 packets over the radio interface, the registration request comprising a network access identifier (NAI) to the source TNAP 703 that indicates that the UE requests “5G connectivity” to a specific operator and/or administrative domain (e.g., public land mobile network (PLMN)).

The provision of this NAI triggers the source TNAP 703 to send an AAA request to the source TNGF 705 during 7003. The source TNGF 705 operates as an AAA proxy. Between the source TNAP 703 and source TNGF 705, the EAP packets signalled after being encapsulated into AAA messages.

During 7004, the source TNGF 705 forwards the Registration Request received from the UE 701 via the signalling of 7003 to AMF 707. This signalling of 7004 may be comprised in an N2 message that comprises N2 parameters (such as, for example, a Selected PLMN identifier corresponding to the network access identifier) and a cause for the establishment).

During 7005, the UE 701 and source TNAP 703 exchange signalling. This signalling may comprise a TNGF key (e.g., PMK-R0) that is created in the UE 701 and in the AMF 707 as part of a successful authentication. A TNAP key (PMK-R1) may be derived from the PMK-R0 for use in establishing layer-2 security between the UE and TNAP. In the case of IEEE 802.11, a 4-way handshake may be executed during 7005 that establishes a security context between the WLAN access point and the UE that is used to protect unicast and multicast traffic over the air.

During 7006, the UE 701 and TGNF 705 exchange signalling. During this signalling of 7006, the UE 701 receives an Internet Protocol (IP) configuration from the TGNF 705 for setting up an IP connection therebetween.

During 7007, the UE 701 and TGNF 705 exchange signalling. During this signalling of 7007, the TGNF 705 provides the UE 701 with an “inner” IP address, a non-access stratum (NAS) IP address (NAS_IP_ADDRESS) and a Transmission Control Protocol (TCP) port number and a Differentiated Services Code Point (DSCP) value. After 7007, an IPsec SA is established between the UE and source TNGF. This is referred to in 3GPP as the “signalling IPsec SA” and operates in Tunnel mode.

During 7008, the UE 701 and TGNF 705 exchange signalling. after the NWt connection (e.g., the connection between the UE and the TNGF) is successfully established. This signalling comprises the UE signalling the source handover TNGF 705 with a NAS

During 7009, the source TNGF 705 exchanges signalling with the AMF 707. This signalling comprises an N2 Initial Context Setup request message. The source TNGF 705 forwards an NAS Registration Accept message received from the AMF 707 to the UE 701 via the established NWt connection. After this has been established, the UE 701 can signal traffic to the 5GC via the source TNGF 705.

WLAN IEEE 802.11 has defined a procedure called ‘Fast Basic Service Set Transition (FT)’ through IEEE 802.11r-2009. This procedure may lead to faster handover and shorter service breaks. However, the deployment and integration of FT within a single TNAN, as well as for intra-TNGF and inter-TNGF mobility, has never been considered.

FT allows a client device to roam quickly in environments implementing Wi-Fi Protected Access 2 (WPA2) Enterprise security, by ensuring that the client device does not need to re-authenticate to the RADIUS server every time it roams from one access point to another. This is accomplished by altering the standard authentication, association, and four-way handshake processes used when a device roams (i.e., re-associates) to a new Wi-Fi access point.

The following lists steps that are performed in Wi-Fi for regular authentication as a client device connects to an access point or roams from one access point to another.
1. Authentication (client)
2. Authentication Response (access point)
3. (Re) Association Request (client)
4. (Re) Association Response (access point) WPA2 Enterprise 802.1X/EAP (client, access point, and authentication server) also includes the following steps (which are skipped in WPA2 Personal)
5. Four-way handshake #1—access point nonce passed to client (access point)
6. Four-way handshake #2—Supplicant nonce passed to access point (client)
6.5 Derivation of encryption key (access point & Client independently)
7. Four-way handshake #3—verification of derived encryption key and communication of group transient key (access point)
8. Four-way handshake #4—acknowledgement of successful decryption (client)

A nonce is a pseudo-random number generated for the purpose of seeding the encryption algorithm. Both the access point (anonce) and the client supplicant device (snonce) generate their own nonces as part of the above-mentioned negotiation.

The following lists the revised—802.11r—steps followed by a client device as it uses Fast BSS Transition (FT) to move from one access point to another.
1. FT authentication; includes PMK seed information from original association and supplicant nonce (client)
2. FT authentication response—includes PMK seed information and access point nonce (access point)
2.5 Derivation of encryption key (access point & Client independently)
3. FT re-association request—verification of derived encryption key (client)
4. FT re-association response—acknowledgement of successful decryption and Group Transient Key (access point)

This FT process works for both WPA2 Enterprise and WPA2 Personal re-associations. In both cases, the eight messages passed between an access point and a client device for authentication, association, and the four-way handshake are reduced to four messages.

In general, FT enables a client to be “vouched for” after the client connects to a first access point on the Wi-Fi network. This means that when that vouched for client roams to a new access point, information from the original association is passed to the new access point for providing the client with credentials. The new access point therefore knows that this client has already been approved by the authentication server, and thus need not repeat the whole 802.1X/EAP exchange again.

FT also introduces efficiencies into the process of establishing the new encryption key between the new access point and the client device, which benefits both WPA2 Personal (a.k.a. pre-shared key or passphrase) and WPA2 Enterprise (a.k.a. 802.1X or EAP). Support for 802.11r is advertised in the access point beacon and probe response frames.

Fast Transition capability has been introduced through IEEE 802.11r-2009 to mitigate the longer interrupts of connectivity during handover that are mainly caused by the much more comprehensive signaling to re-establish the WLAN security context at the target access point after reassociation. Fast Transition introduced a two level key hierarchy that provides the possibility to derive secondary Pairwise Master Keys (labelled as PMK-R1 herein) from a single primary Pairwise Master Key (labelled as PMK-R0 herein) that was generated through an initial EAP authentication exchange. Respective derived unique secondary PMKs may be distributed to each of the access points of the same mobility domain. This keying extension removes the necessity to re-perform EAP (re-) authentication for each transition between adjacent access points. A mobility Domain is a set of basic service sets (BSS) within a same Extended Service Set (ESS), which supports Fast BSS Transition between themselves. A mobility domain is usually limited to the WLAN access points of a single bridged domain, i.e. at the most to the TNAPs of a single TNGF.

Deploying IEEE 802.11 Fast Transition methods that is widely deployed in commercially available WLAN devices and access points can speed up WLAN handover within a single mobility domain beyond what could be achieved through the EAP Re-authentication Protocol as specified in RFC 6696, which is only very rarely implemented in commercial WLAN equipment.

The usage of IEEE 802.11r Fast Transition introduces the use of a key hierarchy comprising a first key (PMK-R0, also referred to herein as a primary pairwise master key or primary PMK) established at the non-access stratum (NAS) signalling in the TNGF during EAP authentication (instead of the PMK1 shown above with respect to FIG. 7). PMK-R0 is used for the establishment of the IPsec tunnel, and replaces the PMK1 previously used.

However, PMK-R0 is not directly used at the WLAN access point and WLAN UE to secure the communication over the air. Instead, the TNGF derives an access point-specific key, PMK-R1 (also referred to herein as a secondary pairwise master key, or secondary PMK), that is forwarded to the access point and used for link layer encryption between access point and UE. In other words, in the example of FIG. 7, PMK-R0 and/or PMK-R1 may be used for communications between the UE and the source TNAP 703, PMK-R1 may be used for communications between the source TNAP and the source TNGF, and PMK-R0 may be used for communications between the source TNGF and the AMF and/or UPF.

All the access points, that can be served by the key distribution of the NAS in the TNGF build a mobility domain, that is signalled in beacon frames and probe responses to UEs to allow the UE to determine, whether Fast Transition can be pursued during a handover procedure.

Aside from the PMK-R0/PMK-R1 key hierarchy, which allows fresh encryption keys for each of the access points within a mobility domain without repeating the EAP authentication procedure or demanding the rarely supported EAP Reauthentication procedure, the Mobility Domain Information Element (MDIE) that is transmitted in beacons and probe responses, there is an FTIE (Fast Transition Information Element) that is carried in addition in 802.11 authentication frames and reassociation frames to allow performing 4-way handshake for generation of the working temporal keys piggybacked to the authentication and reassociation frame exchanges further reducing handover latency by another 4 message transfers. An access point uses the MDIE it broadcasts to advertise that it is included in the group of APs that constitute a mobility domain, to advertise its support for FT capability, and to advertise its FT policy information.

Two different Fast Transition methods are specified, depending on whether there is peer-to-peer communication available between the serving access point and the target access point. These are known as “Fast Transition over the Distribution System” and as “Fast Transition over the Air”. These are discussed further below. Which, if any, FT method is supported by a particular access point may be signalled using an access point's MDIE.

When peer-to-peer communication over the distribution system is feasible, the UE can initiate Fast Transition at the serving access point exchanging the first two messages with the target access point while still being connected with the serving access point and still being able to transfer user data. Only for the reassociation request and reassociation response is the transfer of user data is interrupted and briefly stalled. The procedure is called Fast Transition over the Distribution System.

When peer-to-peer communication over the distribution system is not possible, the UE has to stop transferring user data, and perform the complete message exchange with the target access point over the air. Therefore the break of user data transfer takes longer. The procedure is denoted as Fast Transition over the Air.

Most of the public WLAN access networks provide a secured access mode (currently based on WPA2/3-Enterprise security protocols) with automatic attachments of UEs through their Subscriber Identification Module (SIM) credentials and/or their Authentication and Key Agreement (AKA) credentials. However, when deploying IPsec security for the connectivity between a UE and a 5GC, there is no need for link layer security on the trusted WLAN link. The non-trusted non-3GPP access therefore does not mandate the use of a WLAN mode of access authentication (e.g., the WPA2/3-Enterprise security protocols), and instead uses the 5G-EAP authentication method only for establishing the security association for the IPsec tunnel (which may be based on the IKEv2 protocol).

Worldwide roaming across such secured access mode public WLANs is currently getting widely deployed through the OpenRoaming project of the Wireless Broadband Alliance (WBA), which is an organization that aims to reduce an operational overhead of becoming partner in global roaming consortia.

The WLAN technology deployed in OpenRoaming networks is the same that is used by mobile operators in their own trusted WLAN access networks. With such convergence of the access technology, it becomes feasible that a mobile operator establishes global WLAN roaming capabilities for their subscribers by leveraging OpenRoaming techniques and demand of seamless mobility across all the WLAN accesses because of the compatible security levels. A mobile operator can even signal a single, worldwide mobility domain through virtual WLAN access networks indicating the same service set identifier (SSID) and mobility domain across multiple WLAN access providers.

Even when such a deployment scenario formally does not fully correspond to the trusted WLAN access architecture of 3GPP, access procedures defined for trusted WLAN access could be deployed to provide an extended coverage access infrastructure that comprises several access networks belonging to different access providers, each access network being connected to the 5GC through a respective, dedicated N3IWF. In this case, each N3IWF would exactly behave like the TNGF and could establish a wide area WLAN access across multiple WLAN access domains under the control of a 5G mobile network operator.

While mobility is specified by current 3GPP specifications only within a single TNAN with the potential enhancement of usage of EAP Re-authentication Protocol as specified in RFC6696 to speed up handovers, intra-TNAN mobility has not been considered.

An example architecture of intra-TNGF handover/mobility procedures is illustrated with respect to FIG. 8.

FIG. 8 illustrates an example deployment in which a UE 801 may connect to an AMF and/or a UPF 802 via at least one of two different paths. The first path comprises a first TNAP 803A that connects to AMF/UPF 802 via a first interworking function 804A (e.g., an N3IWF or a TNGF). The second path comprises a second TNAP 803B that connects to AMF/UPF 802 via a second interworking function 804B (e.g., an N3IWF or a TNGF).

The following recognizes that it would be useful to have 3GPP Xn/N2 mobility procedures based on inter NG-RAN handover procedures that do not tear down and reestablishment of the IPsec tunnel. This may be achieved by enabling the Target TNGF to provide a UE identifier (e.g., the UE MAC address) as well as identifiers of the source and target access points (e.g., respective MAC addresses for those entities) to the Source TNGF. The Source TNGF may subsequently replay with EAP re-authentication root key (Rrk) and the IPSec related parameters (e.g., the Security Parameters Index (SPI), which is an identifier used to uniquely identify IPSec Security Associations, and may be configured/set by a customer (e.g., for manual Security Associations) or by an Internet Key Exchange Daemon (IKED) (e.g., for dynamic Security Associations)), list of SA (Security Association), the traffic filters per SA, the IPSec Sequence Numbers per SA).

Even with EAP RE-authentication Protocol, handovers between adjacent TNAPs require full reestablishment of the WLAN link layer encryption keys following the EAP re-authentication.

For example, the Access Gateway Function (AGF) of 5G Fixed Mobile Convergence (FMC) is responsible for serving a specific access area, and IP address renew is required when UE moves to another access area in fixed network. Similarly, the current 3GPP architecture for integration of Wi-Fi with the 5GC allows only spotty coverage without seamless mobility support between adjacent Wi-Fi access areas. Each of the Wi-Fi access networks defined through a N3IWF/TNGF establishes an independent access area and requires full re-authentication and re-authorization when UEs moves between them. In current 3GPP specification, there isn't any mobility support available for transition within a same N3IWF, within a same TNGF, between different N3IWF, and between different TNGFs. In other words, current 3GPP specifications do not comprise any mobility support for intra-TNGF transitions, inter-TNGF transitions, intra-N3IWF transitions, and/or inter-N3IWF transitions.

The lack of mobility procedures can be problematic for time-critical applications (such as voice-based applications), which can experience severe service degradation due to extended breaks that are caused through the reestablishment of the security association during handover. IEEE 802.11 would like to provide for much shorter interruptions through Fast Transition, and introduced this feature into IEEE 802.11r. However, the support of Fast Transition between adjacent access points belonging to different N3IWF/TNGF access zones (e.g., service areas) is not addressed in current 3GPP specifications and does not work.

For untrusted non-3GPP networks, in current 3GPP specification, N3IWF support local mobility anchor within untrusted non-3GPP access networks using MOBIKE, which is defined in IETF RFC 4555. MOBIKE is a 5GC dual-homing solution that supports intra-N3IWF handover for the user plane, which could be required when a single N3IWF serves multiple WLAN access areas that deploy different SSIDs and do not provide link layer mobility. This makes a UE to change the UEs' IP address when moving from one area to another.

On the UE side, an adaptor was introduced by setup operator self-servicing cells to simulate eNB/gNB behaviour. The UE Adaptors offer a proprietary voice service mobility solution between N3IWF and TNGF.

The problem of faster handover of WLAN UEs between different (e.g., adjacent) TNGFs has been discussed within 3GPP and has been addressed through chapter 7.1.3.5 of TR 23.716.

Chapter 7.1.3.5 of TR 23.716 proposes leveraging the use of EAP Re-authentication Protocol RFC6696 to avoid a complete re-authentication process after handover between different TNGFs. This utilizes many message roundtrips between WLAN access authenticator and authentication server.

To enable and prepare for efficient intra-TNGF mobility (i.e. handover across different TNAPs connected to the same TNGF), the following proposes to leverage IEEE 802.11 Fast Transition methods instead of the previously proposed EAP Re-authentication Protocol as specified in RFC 6696 for generation of fresh keys during handover across adjacent TNAPs of the same TNGF. This means that a full EAP authentication procedure with the AMF does not have to be performed by the target access technology, and there is no need to re-perform the 4-way-handshake for generation and activation of the working keys. IEEE 802.11 Fast Transition is widely supported in commercial UEs as well as in bridged WLAN access networks operated with a central WLAN controller for configuration and security management.

In particular, instead of performing a complete EAP authentication message exchange, the pair master key (PMK) used by the target TNGF for authenticating the UE can be generated through local generation of the PMK at the EAP Re-authentication server using previously generated master keys. This process speeds up the establishment of the PMK of the target TNGF, but still requires full sequence of network entry signalling in WLAN IEEE 802.11, e.g., 4-Way handshakes. In other words, this mechanism still leads to longer interruption periods during WLAN handover compared to non-WLAN handovers, which potentially severely impacts the quality of time critical services like VoWLAN/VoWi-Fi. Therefore, TR23.716 has identified the issues and requirements involved in inter-WLAN mobility, but finally does not provide a mechanism that really addresses the needs of mission critical services.

The following addresses the amendment of the Xn interface (e.g., an interface between different access points, including interfaces between two TNGFs) and/or N2 interface (e.g., an interface between an access point (e.g., a TNGF) and an access and mobility function (AMF) located in a 5G network). for Wi-Fi specific attributes and functions to enable fast transition support and seamless handover in order to maintain service quality even for demanding applications like VoWi-Fi.

In WLAN, the handover process is triggered by a UE based on the UE's link quality measurements and auxiliary information received from the serving access point. The auxiliary WLAN handover information has been specified in IEEE 802.11k and IEEE 802.11v. Wi-Fi Alliance mandates the subset of information elements that are to be supported by UEs and access points that support Fast Transition.

The UE is configured to measure and periodically report to its serving access point with the WLAN access point/TNAP identity and signal quality metrics of all neighbor access points, even of access points belonging to different WLAN access networks. To guide the handover decision, the UE receives from the serving access point information about the neighboring environment.

To enable Fast Transition, all access points/TNAPs belong to the same mobility domain. This mobility domain is usually restricted to the access points/TNAPs served by a single interworking function. However, modern WLAN equipment allows the configuration of multiple service set identifiers (SSIDs), with each SSID being usable for establishing access via a dedicated WLAN access network. When mobile operators seek for support of seamless mobility across WLAN access networks, they can establish through business agreement with the local WLAN network owner, that there is the same SSID supported across multiple independently owned WLAN access networks, each indicating the same Mobility Domain identifier.

In such configuration, the UEs may assume that all the visible access points (including TNAPs and 3GPP access points) belong to the same access network (even across multiple interworking functions). As a result of this, UEs may Fast Transition messaging when reassociating from an access point belonging to one interworking function to an adjacent access point belonging to another interworking function.

To allow for such configuration, it is proposed to enhance signaling between adjacent interworking functions to serve Fast Transition procedures in a variety of different network configurations, including across different WLAN access networks.

To address at least one of the above-mentioned issues, the following proposes mechanisms for enabling targets enhanced seamless mobility of standard WLAN UEs within a TNAN served by a single TNGF or across multiple TNGFs (/N3IWFs), via evolved 3GPP Xn/N2 mobility procedures based on inter NG-RAN handover procedures without tearing down and reestablishment of the IPsec tunnel and without the involvement of any EAP signalling to re-establish security means in the WLAN link layer.

To achieve this goal, standard IEEE 802.11 Fast Transition procedures are enabled within a single TNGF area, or across multiple TNGFs carrying the keying material forward to allow the target TNGF to enable Fast Transition procedures and seamlessly re-establish IPsec connectivity.

Compared to previously used mechanisms, the presently described techniques enable much quicker handovers between WLAN access zones (e.g., between WLAN service areas) served by a single or different TNGFs through introduction of IEEE 802.11 Fast Transition support over existing 3GPP communication paths. The presently described techniques may be aligned to the procedures of XN OR N2 SUPPORTED INTER-TNGF MOBILITY. The same pre-assumptions apply for the configuration of the WLAN access networks attached to different TNGFs. Even when the networks belong to different operational domains (e.g., to different public land mobile networks (PLMNs)), seamless handover is still feasible when agreements exist between the operators for harmonizing the treatment of WLAN operation.

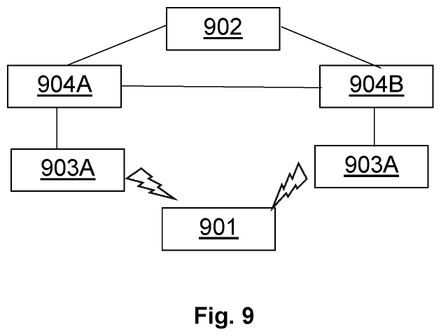

FIG. 9 illustrates a network configuration in which the presently described techniques may be deployed. In this example of FIG. 9, there is shown a UE 901 that may connect to an AMF and/or a UPF 902 via at least one of two different paths. The first path comprises a first TNAP 903A that connects to AMF/UPF 902 via a first interworking function 904A (e.g., an N3IWF or a TNGF). The second path comprises a second TNAP 903B that connects to AMF/UPF 902 via a second interworking function 904B (e.g., an N3IWF or a TNGF). The first and second interworking functions 904A, 904B may comprise an interface therebetween (e.g., an Xn interface) for exchanging information.

These mechanisms may be effected by providing new signalling within the TNAN, new information elements in the N2/Xn signaling, and/or new supportive functions in the interworking function interfacing an access network to the 5GC (e.g., a new N3IWF and/or TNGF). This may enable the 5GCN to support Fast Transition within an access area served by multiple interworking functions, which establishes a common mobility domain that was not previously possible. The same messaging changes may support the deployment of FT inside a TNAN served by a single TNGF.

For example, the following additional functions may be provided in the interworking function.

First, the interworking function may generate and store PMK-R0. The PMK-R0 may be derived from the PMK provided by the AMF according to the IEEE 802.11 specification.

Second, the interworking function may generate and forward the secondary PMK-R1 to the serving access point to which the UE initially attaches with complete EAP authentication.

Third, the interworking function may generate and locally store secondary PMK-R1s for other access points belonging to a WLAN access network local to the serving access point. This WLAN access network is referred to herein as a “local WLAN access network”.

Fourth, the interworking function may provision at least one PMK-R1 to the local access points in the case that a UE performs Fast Transition towards an access point inside the local WLAN access network.

Fifth, inter-interworking function messaging may be provided for forwarding keying material to a target WLAN access network (e.g., not the local WLAN access network) in the case that Fast Transition is performed across WLAN access networks in the serving area of different interworking functions. This may be implemented in at least one of two different ways.

For example, PMK-R0 may be provided to an interworking function of the target WLAN access network when the UE moves into a coverage area provided by the target access network. In this case, the target interworking function may generate PMK-R1s for all the access points within the target WLAN access networks. This mechanism may utilize a highly secure and trustworthy transfer protocol between adjacent interworking functions (such as, for example, procedures already defined for providing Xn and/or N2 security).

As another example, a target interworking function may be authorized to identify a serving interworking function after being contacted for providing access for the UE to the 5GC. The serving interworking function may subsequently be signaled, by the target interworking function, a request for keying material associated with a moving UE. In this example, a directory service across multiple interworking functions may be provided that lists current PMK-R0 storage location of all UEs. At least one identifier associated with a UE (e.g., a Medium Access Control (MAC) address of the UE) can be used as an identifier of the UE when accessing this directory. The at least one identifier may be an identifier of the UE that is maintained during a transition between different access points.

Sixth, the interworking function may exchange inter-interworking function signalling for providing further configuration parameters related with the UE. For example, the interworking function may provide information for allowing the new interworking function (e.g., a TNGF or N3IWF) to issue an NGAP/N2 Path Switch Request with correct NGAP parameters. The correct NGAP parameters may comprise all parameters of PDU Session resources that were established over a source TNGF, together with radio resource management (RRM) information of adjacent WLAN access networks to provide more seamless auxiliary WLAN environment information, guard timers for guaranteeing an FT Request and N2 handover is pipelined with UE, TNGF and AMF during N2 based handover use Fast Transition over the Air.

For example, a handover target N3IWF/TNGF may send an N2 Path Switch Request message to an AMF to inform the AMF that the UE has moved to a new target WLAN and to provide the AMF with a list of PDU Sessions to be switched by the AMF. Access node tunnel information for each PDU Session to be switched may be comprised in the N2 session management Information.

In the case of Intra-TNGF mobility, when the source TNGF and the target TNGF are the same, no Xn/N2 signalling may take place. In this example, messaging between the TNAP and TNGF is the same, regardless whether FT is performed inside a TNAN served by a single TNGF, or across multiple TNGFs.

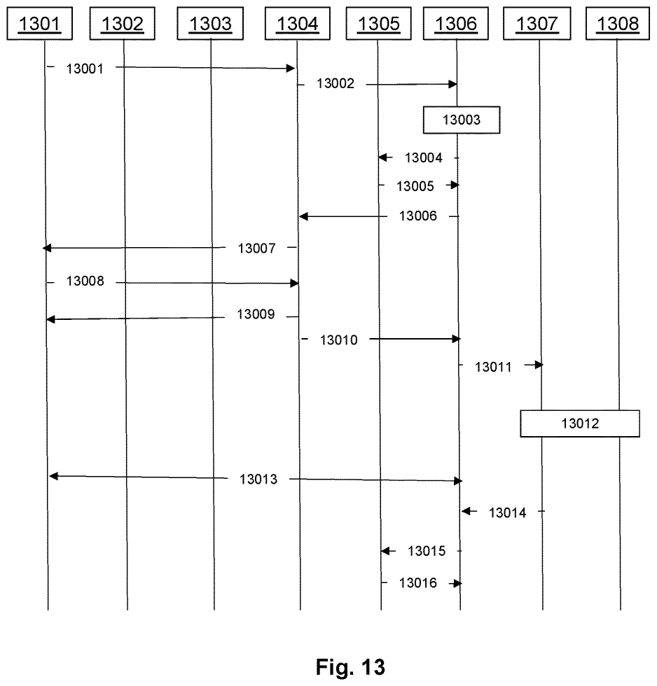

The following provides examples illustrating how the presently described techniques may be implemented in different deployments. In particular, FIGS. 10 to 12 illustrate example signalling relating to “FT over the distribution system” while FIGS. 13 to 15 illustrate example signalling relating to “FT over the air”.

Initial WLAN connectivity is performed with Fast Transmission mode enabled. This means that following EAP-SIM/EAP-AKA authentication a primary pairwise master key (PMK-R0) is established at the Authenticator (i.e., an entity causing the authentication of the UE, which may be the source TNGF), that provides the possibility to derive PMK-R1 pairwise master keys for distribution to other access points within the same defined mobility zone.

The UE that is authenticated may perform WLAN-related measurements for measuring signal quality and/or experience quality on transmitted and/or received signals that are respectively transmitted and/or received via the WLAN. The UE may receive information on a surrounding network neighbourhood from the UE's serving access point that provides guidance for assisting the UE to find access points providing a predetermined connectivity.

The UE may determine, based on internal policies configured in the UE, that the current WLAN radio link providing by the serving access point, does not provide a predetermined quality of service and/or quality of experience. Based on (e.g., in response to) such a determination, the UE scans the surrounding radio environment and selects a target access point for providing a handover to in order to maintain the predetermined quality of service and/or quality of experience. In particular, the UE checks and verifies that the target access point is associated with the same SSID and mobility domain as the serving access point.

Depending on the WLAN infrastructure, at least two different WLAN FT (Fast Transition) modes are possible.

As mentioned above, one type of FT mode is known as FT over the Distribution System. This FT mode relates to when serving access points have the possibility to contact other access points of the same mobility domain directly.

Another type of FT mode is known as FT over the Air. Under FT over the air, the UE establishes a new security context directly with the new target access point without the need of signaling between serving and target access point.

These two FT modes will be considered separately.

First, FT over the distribution system (DS) will be considered.

During, the UE sends an FT Action Request message via the serving access point to the target access point. As the target access point may belong to a different WLAN access zone belonging to another TNGF, the message is relayed to the serving TNGF and the target TNGF that could be determined through the information provided by the UE in its FT Action Request. As the serving TNGF is the key holder of PMK-R0, the serving TNGF forwards the PMK-R0 to the target TNGF to allow the target TNGF to generate and to allocate PMK-R1 at the target access point.

The target access node processes the information comprised in the FT information element received from the source access point, and responds to the source access point with a revised FT information element via the target TNGF and source TNGF to proceed the rekeying procedure.

After successful completion of the WLAN Fast Transition, which includes a relocation of the IPsec tunnel across different access zones (e.g., across different service areas), the PMK-R0 is removed at the source TNGF and continues to exist only at the target TNGF.

FIG. 10 illustrates an example of how FT over the DS may be performed for inter-TNGF WLAN Fast Transition over the Distribution System across multiple TNGFs through the Xn interface.

FIG. 10 illustrates signalling that may be performed between a UE 1001, a gNB 1002, a source access point 1003, a target access point 1004, a source TNGF 1005, a target TNGF 1006, and an AMF 1007. It is assumed that the UE is configured with primary key material (which will be referred to as PMK-R0 herein) and at least one secondary key material (which will be referred to as at least one PMK-R1 herein) derived from PMK-R0, and the source TNGF is configured with PMK-R0.

Prior to performing any handover, the UE performs WLAN measurements for determining whether a handover is to be requested from the source access point 1003 to the target access point 1004. This determination may be further performed based on neighborhood information delivered to the UE 1001 from the source access point that provides information for discovering target access point 1004.

This means that when UE determines, based on the UE's preconfigured internal policies, that the current WLAN radio link does not provide the required level of service, the UE 1001 scans the environment and selects a target access point that exposes the same Mobility Domain Information Element (MDIE) as the source access point for the most seamless handover to maintain the required quality of service. The MDIE may be as described above. The chosen target access point may indicate, aside from the same MDIE, a same SSID as the source access point, and eventually Homogenous Extended Service Set Identifier (HESSID) (when provided). The HESSID attribute comprises an address (e.g., a MAC address) that identifies the Homogenous Extended Service Set. The HESSID is a globally unique identifier that, in conjunction with the SSID, may be used to provide network identification for a subscription service provider network (SSPN). This process is currently described in Section 8.4.2.94 of IEEE-802.11.

Further, with knowledge of the target access point MAC address, the UE 1001 is able to calculate a new PMK-R1 that is used for the derivation of the working cyphering keys for ciphering communications to the target access point 1004. Subsequent to making the determination to perform the handover operation, the UE proceeds to 10001.

During 10001, the UE 1001 signals the source access point 1003. This signalling may be performed while the UE 1001 is still connected to the source access point 1003 for receiving services (e.g., while still being connected to the source access point 1003 for exchange of user data).

The signalling of 10001 may comprise an FT Action Request message that comprises an identifier of the target access point 1004 (e.g., the target access point's MAC address) and the Fast Transition Information Element (FTIE1). Fast Transition processes involve embedding the 4-way handshake of WLAN procedures into authentication and reassociation message exchanges. FTIE1 comprise the information elements of the first message of the 4-way handshake that are to be forwarded to a target access point for calculating the second message of 4-way handshake information to be embedded in the response frame. Analogously, the later mentioned FTIE2 may comprise the information elements of the second message of 4-way handshake that are to be forwarded to target access point for calculating the third message of the 4-way handshake information to be embedded in a response frame, and so on for FTIE3 and FTIE4.

This signalling of 10001 may cause the source access point 1003 to prepare for a fast transition of the UE 1001 from the source access point 1003 to the target access point 1004 through preestablishment of the required keying material.

During 10002, the source access point 1003 signals the source TNGF 1005. This signalling of 10002 may comprise information comprised in the signalling of 10001. This signalling of 10002 may cause the source TNGF 1005 to determine whether the target access point 1004 belongs to the source TNGF 1005 (and may thus use a standard Fast Transition procedure between two access points served by the same TNGF), or whether the target access point 1004 belongs to another TNGF that the TNGF 1005 (and therefore the desired transition addresses another TNAN served by another TNGF).

When the target access point 1004 belongs to another TNGF than the source TNGF 1005 (which may be determined by examining the identifier of the target access point provided in the signalling of 10002), the source TNGF 1005 proceeds to 10003.

During 10003, the source TNGF determines (e.g., identifies) the target TNGF 1006 via the target access point identifier (e.g., via the target MAC address). The source TNGF 1005 may use any mechanism for determining the target TNGF.

For example, the source TNGF 1005 may determine the target TGNF 1006 using a preconfigured (in the source TNGF 1005) list of access points that serve neighbouring TNGFs neighbouring to the source TNGF 1005.

As another example, the source TNGF may use a common database and/or registry (e.g., an NRF) for performing the determination. As one example, each TNGF (including the target TNGF) may registers its address (e.g., its Xn address) onto an NRF with a respective associated list of MAC addresses of access point that TNGF serves. This registration may be performed using, for example, an Nnrf_NFManagement_NFRegister service operation (which is defined in 3GPP TS 23.502). Such a determination may be performed by the source TNGF discovering the target TNGF by performing, for example, an Nnrf_NFDiscovery_Request operation defined in 3GPP TS 23.502, providing the target access point MAC address as input parameter

During 10004, the source TNGF 1005 signals the target TNGF 1006 determined during 10003. This signalling of 10004 may comprise information received during 10002 (e.g., the FTIE1 received during 10002). This signalling of 10004 may comprise the Global-PMK (e.g., PMK-R0). This signalling of 10004 may be performed using, for example, an Xn UE Context Fwd message service operation.

During 10005, the target TNGF 1006 signals the target access point 1004. This signalling of 10005 may be performed after the target TNGF 1006 has derived PMK-R1 from the received PMK-R0. This signaling may be performed based on the information received from the source TNGF during 10004. This signalling may inform the target access point 1004 about the upcoming handover. This signaling may comprise PMK-R1. This signalling may comprise an identifier of the UE 1001 being handed over. This signalling may comprise respective identifiers (e.g., respective MAC identifiers) of the target access point 1004 and of the source access point 1003. The signalling of 10005 may be performed using an FT_Indication message.

With the information received from the target TNGF 1006 during 10005, the target access point uses the received PMK-R1 to calculate working keys (e.g., keys used for encrypting communications between the UE and the target access point) and content of a resulting FTIE (labelled FTIE2 herein). This FTIE2 is signalled from the target access point 1004 to the target TNGF 1006 during 10006. FTIE2 may be as discussed above in relation to FTIE2. The signalling of 10006 may comprise the identifier of the UE 1001 and the respective identifiers of the target access point and the source access point. The signalling of 10006 may be provided via an FT-Confirmation message.

During 10007, the target TGNF 1006 signals the source TNGF 1005. This signalling may comprise FTIE2. This signalling may be comprised in an Xn UE Context Fwd message.

During 10008, the source TGNF 1005 signals the source access point 1003. This signalling may comprise FTIE2. This signalling may comprise an identifier of the UE. This signalling may comprise the respective identifiers of the source access point and the target access point.

During 10009, the source access point 1003 signals the UE 1001. This signalling may comprise a response to the signalling of the signalling of 10001. This signalling may comprise an FT action response service operation. This signalling may be provided to the UE 1001 over the air when the UE is still able to perform user data transmission over the source access point towards the 5GC. This signalling of 10009 may comprise FTIE2.

Having received the necessary preparatory information to execute the final step of fast transition, during 10010, the UE 1001 adjusts its radio parameters for transmission and/or reception, and issues an IEEE 802.11 Reassociation Request message to the target access point 1004.

During 10011, the target access point 1004 responds to the signalling of 10010. This response may be performed based on (e.g., using) the information already available at the target access point. This means that the target access point 1004 may immediately respond to the request of 10010 with a corresponding IEEE 802 Reassociation Response message to conclude the transition and enable the UE to continue exchanging user data with the 5GC via the target access node.

During 10012, which may be performed simultaneously with or in series to the signalling of 10011, the target access point 1004 signals the target TGNF 1006. This signalling of 10012 may indicate that a FT procedure has been successfully completed between the target access point 1004 and the UE 1001. This signalling of 10012 may comprise an identifier of the UE 1001. This signalling of 10012 may comprise respective identifiers of the source access point 1003 and the target access point 1004. This signalling of 10012 may cause the target TNGF 1006 to activate any IPsec endpoint of the transitioned UE that has been prepared at the target TNGF since the handover was indicated together with provisioning of the necessary keying material by the source TNGF.

During 10013, the target TNGF 1006 and the UE 1001 exchange signalling. This signalling relates to establishing an IPSec endpoint at target TNGF. For example, this signalling may cause a previous IP connection of the UE 1001 to be continued using a previous IP context used by the UE 1001 with the source TNGF 1005. Further, this signalling may cause an IPSec tunnel usage between the UE 1001 and the target TNGF 1006 that is still based on use of the PMK-R0 security association.

During 10014, the target TNGF 1006 signals the source TNGF 1005. This signalling may indicate that the handover operation of the UE from the source access point 1003 to the target access point 1004 has been successfully completed.

During 10015, based on the signalling of 10014, the source TNGF 1005 signals the target TNGF 1006 to indicate that that source TNGF 1005 has disabled IPSec endpoint for the UE at the source TNGF 1005, that the source TNGF 1005 has removed any local storage of the PMK-R0 at the source TNGF 1005, and to forward data (e.g., user plane data) for the UE to the target TNGF 1006 that had not previously been forwarded to the target TNGF 1006 by the source TNGF 1005.

During 10016, the target TNGF 1006 signals the AMF 1007. This signalling may comprise a path switch request for causing data for the UE 1001 to be forwarded to the target TNGF 1006 instead of to the source TNGF 1006.

During 10017, the target TNGF 1006 and AMF 1007 exchange signalling for causing a packet data unit (PDU) session for the UE 1001 to be updated to render the TNGF 1006 as an endpoint for user data for the UE 1001. This may be performed in accordance with 3GPP standards (e.g., in accordance with 3GPP TS 23.502).

During 10018, the AMF 1007 signals the target TNGF 1006 to indicate that the path switch request has been successfully completed.

During 10019, the target TNGF 1006 signals the source TNGF 1005 to indicate that the source TNGF 1005 may release any resources currently reserved by the source TNGF 1005 for use for the UE 1001. The source TNGF 1005 may perform that release based on receipt of the signalling of 10019.

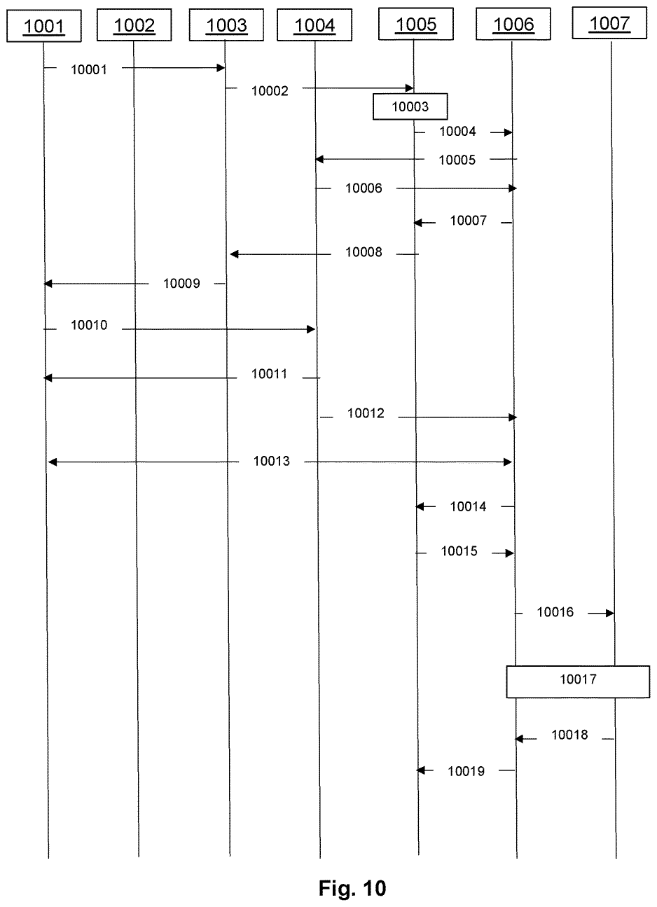

FIG. 11 illustrates another example of FT over the DS. The example of FIG. 11 relates to support for providing inter-TNGF WLAN FT over the DS across multiple TNGFs through the N2 interface.

FIG. 11 illustrates signalling that may be performed between a UE 1101, a gNB 1102, a source access point 1103, a target access point 1104, a source TNGF 1105, a target TNGF 1106, an AMF 1107 and a 5GC network function 1108 (e.g., an SMF and/or a UPF). It is assumed that the UE is configured with PMK-R0 and at least one PMK-R1 derived from PMK-R0, and the source TNGF is configured with PMK-R0.

Prior to performing any handover, the UE performs WLAN measurements for determining whether a handover is to be requested from the source access point 1103 to the target access point 1104. This determination may be further performed based on neighborhood information delivered to the UE 1101 from the source access point that provides information for discovering target access point 1104.

This means that when UE determines, based on the UE's preconfigured internal policies, that the current WLAN radio link does not provide the required level of service, the UE 1101 scans the environment and selects a target access point that exposes the same Mobility Domain Information Element (MDIE) as the source access point for the most seamless handover to maintain the required quality of service. The chosen target access point may indicate, aside from the same MDIE, a same SSID as the source access point, and eventually HESSID when provided.

Further, with knowledge of the target access point MAC address, the UE 1101 is able to calculate a new PMK-R1 that is used for the derivation of the working cyphering keys for ciphering communications to the target access point 1104. Subsequent to making the determination to perform the handover operation, the UE proceeds to 11001.

During 11001, the UE 1101 signals the source access point 1103. This signalling may be performed while the UE 1101 is still connected to the source access point 1103 for receiving services (e.g., while still being connected to the source access point 1103 for exchange of user data).

The signalling of 11001 may comprise a FT Action Request message that comprises an identifier of the target access point 1104 (e.g., the target access point's MAC address) and the Fast Transition Information Element (FTIE1), which may be as described above. This signalling may cause the source access point 1103 to prepare for a fast transition of the UE 1101 from the source access point 1103 to the target access point 1104 through preestablishment of the required keying material.

During 11002, the source access point 1103 signals the source TNGF 1105. This signalling of 11002 may comprise information comprised in the signalling of 11001. This signalling of 11002 may cause the source TNGF 1105 to determine whether the target access point 1104 belongs to the source TNGF 1105 (and may thus use a standard Fast Transition procedure between two access points served by the same TNGF), or whether the target access point 1104 belongs to another TNGF that the TNGF 1105 (and therefore the desired transition addresses another TNAN served by another TNGF).

When the target access point 1104 belongs to another TNGF than the source TNGF 1105 (which may be determined by examining the identifier of the target access point provided in the signalling of 11002), the source TNGF 1105 proceeds to 11003.

During 11003, the source TNGF determines (e.g., identifies) the target TNGF 1106 via the target access point identifier (e.g., via the target MAC address). The source TNGF 1105 may use any mechanism for determining the target TNGF.

For example, the source TNGF 1105 may determine the target TGNF 1106 using a preconfigured (in the source TNGF 1105) list of access points that serve neighbouring TNGFs neighbouring to the source TNGF 1105.

As another example, the source TNGF may use a common database and/or registry (e.g., an NRF) for performing the determination. As one example, each TNGF (including the target TNGF) may registers its address (e.g., its Xn address) onto an NRF with a respective associated list of MAC addresses of access point that TNGF serves. This registration may be performed using, for example, an Nnrf_NFManagement_NFRegister service operation (which is defined in 3GPP TS 23.502). Such a determination may be performed by the source TNGF discovering the target TNGF by performing, for example, an Nnrf_NFDiscovery_Request operation defined in 3GPP TS 23.502, providing the target access point MAC address as input parameter.

During 11004, the source TNGF 1105 signals the AMF 1107 to indicate that a handover is to be performed to target TNGF 1106. This signalling may comprise FTIE1 received during 11002. This signalling may comprise PMK-R0. In other words, during 11004, the source TNGF provides the AMF 1107 with Fast Transition information provided through the FT_Request message (FTIE1) together with the identity of the target TNGF and Global-PMK (PMK-R0). This signalling may be comprised in an N2 Handover required request service operation.

During 11005, the AMF 1107 and user plane entities 1108 exchange signalling for preparing for handover of the UE from the source TNGF 1105 to the target TNGF 1106. As part of this preparation (which may be largely in accordance with the handover preparation described in 3GPP standards, such as 3GPP TS 23.502 FIG. 4.9.1.3.2-1 steps 1 to 12) a second FTIE (e.g., FTIE2 as described above in relation to FIG. 10) and PMK-R0 may be exchanged between the AMF 1107 and the 5GC network function 1108.

During 11006, the AMF 1107 signals the target TNGF 1106. This signalling may comprise a handover request for requesting that the UE 1101 be handed over to the target TNGF 1106 from the source TNGF 1105. This signalling may comprise, for example, FTIE1 and PMK-R0. This signalling may be comprised in a handover request service operation.

During 11007, the target TNGF 1106 signals the target access point 1104. This signaling may be performed based on the information received from the AMF during 10006. This signalling may inform the target access point 1104 about the upcoming handover. This signaling may comprise PMK-R1, which has been derived by the target TNGF 1106 using the received PMK-R0. This signalling of 11007 may comprise FTIE1. This signalling may comprise an identifier of the UE 1101 being handed over. This signalling may comprise respective identifiers (e.g., respective MAC identifiers) of the target access point and of the source access point 1103. The signalling of 11007 may be performed using an FT_Indication message.

With the information received from the target TNGF 1106 during 11007, the target access point uses the received PMK-R1 to calculate working keys for communicating with the UE 1101, and content of a resulting FTIE (labelled FTIE2 herein). This FTIE2 is signalled from the target access point 1104 to the target TNGF 1106 during 11008. The signalling of 10008 may comprise the identifier of the UE 1101 and the respective identifiers of the target access point and the source access point. The signalling of 10006 may be provided via an FT-Confirmation message.

During 11009, the target TGNF 1106 signals the AMF 1107. This signalling may be a response to the signalling of 11006. This signalling may comprise the FTIE2. This signalling may be comprised in an N2 handover request acknowledgement. Following the reception and forwarding of the FTIE2 container during 11008 and 11009, the target TNGF initiates and enables an IPsec endpoint for the UE based on the configuration information received from AMF 1107 during 11006.

11010 to 11017 relate to handover of the UE from the source TNGF 1105 to the target TNGF 1106. At least part of these operations may comprise features of operations found in 3GPP TS 23.502 FIG. 4.9.1.3.3-1 steps 6 to 15. Although not explicitly shown or discussed in the below signalling, the handover execution includes interactions with SMF and UPF and UE Context Release Command from the AMF 1107 to the source TNGF 1105.

During 11010, the AMF 1107 signals the source TNGF 1105. This signalling may comprise a handover command. This signalling may comprise FTIE2. This signalling may be signalled using an N2 interface (e.g., using the N2 Hand-Over command message).

During 11011, the source TNGF 1105 signals the source access point 1103. This signalling may be a response to the signalling of 11002. This signalling of 11011 may comprise FTIE2. This signalling of 11011 may comprise an identifier of the UE. This signalling may comprise the respective identifiers of the source access point and the target access point.

During 11012, the source access point 1103 signals the UE 1101. This signalling may comprise a response to the signalling of the signalling of 11001. This signalling may comprise an FT action response service operation. This signalling may be provided to the UE 1101 over the air when the UE is still able to perform user data transmission over the source access point towards the 5GC.

Having received the necessary preparatory information to execute the final step of fast transition during 11012, the UE 1001 adjusts its radio parameters for transmission and/or reception, and issues an IEEE 802.11 Reassociation Request message to the target access point 1104 during 11013.

During 11014, the target access point 1104 responds to the signalling of 11013. This response may be performed based on (e.g., using) the information already available at the target access point. This means that the target access point 1104 may immediately respond to the request of 11013 with a corresponding IEEE 802 Reassociation Response message to conclude the transition and enable the UE to continue exchanging user data with the 5GC via the target access node.

During 11015, which may be performed simultaneously with or in series to the signalling of 11013, the target access point 1104 signals the target TGNF 1106. This signalling of 11015 may indicate that a FT procedure has been successfully completed between the target access point 1104 and the UE 1101. This signalling of 11015 may comprise an identifier of the UE 1101. This signalling of 11015 may comprise respective identifiers of the source access point 11003 and the target access point 1104. This signalling of 11015 may cause the target TNGF 1106 to activate any IPsec endpoint of the transitioned UE that has been prepared at the target TNGF since the handover was indicated together with provisioning of the necessary keying material by the source TNGF.

During 11016, the target TNGF 1106 signals the AMF 1107 to notify the AMF 1107 that handover of the UE to the target access point 1104 has been initiated.

During 11017, the target TNGF 1106 and the UE 1101 exchange signalling. This signalling relates to establishing an IPSec endpoint at target TNGF. For example, this signalling may cause a previous IP connection of the UE 1101 to be continued using a previous IP context used by the UE 1101 with the source TNGF 1105. Further, this signalling may cause an IPSec tunnel usage between the UE 1101 and the target TNGF 1106 that is still based on use of the PMK-R0 security association.

During 11018, the target AMF 1107 signals the source TNGF 1105. This signalling may indicate that the handover operation of the UE from the source access point 1103 to the target access point 1104 has been successfully completed.

During 11019, based on the signalling of 11018, the source TNGF 1105 signals the AMF 1107 to indicate that that source TNGF 1105 has disabled IPSec endpoint for the UE at the source TNGF 1105, and that the source TNGF 1105 has removed any local storage of the PMK-R0 at the source TNGF 1105.

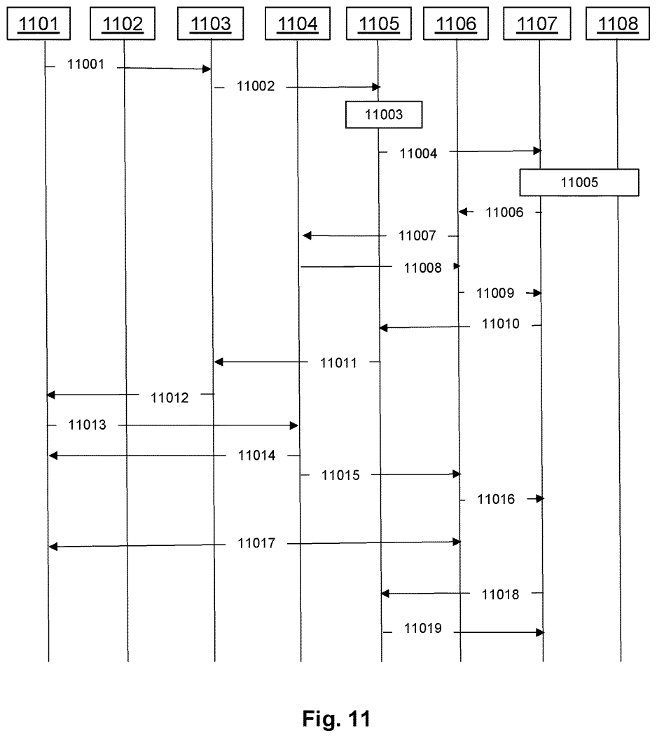

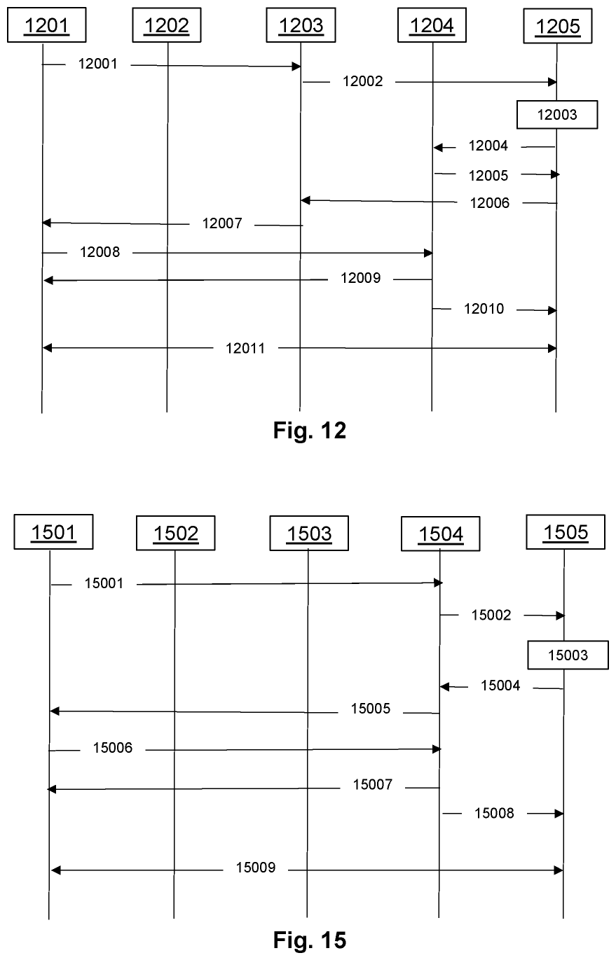

FIG. 12 illustrates another example of FT over the DS. This example of FIG. 12 relates to intra-TNGF WLAN FT over the DS within a single TNGF.

FIG. 12 illustrates signalling that may be performed between a UE 1201, a gNB 1202, a source access point 1103, a target access point 1204, and a source TNGF 1205. It is assumed that the UE is configured with PMK-R0 and at least one PMK-R1 derived from PMK-R0, and the source TNGF is configured with PMK-R0.

Prior to performing any handover, the UE performs WLAN measurements for determining whether a handover is to be requested from the source access point 1203 to the target access point 1204. This determination may be further performed based on neighborhood information delivered to the UE 1201 from the source access point that provides information for discovering target access point 1204.

This means that when UE determines, based on the UE's preconfigured internal policies, that the current WLAN radio link does not provide the required level of service, the UE 1201 scans the environment and selects a target access point that exposes the same Mobility Domain Information Element (MDIE) as the source access point for the most seamless handover to maintain the required quality of service. The chosen target access point may indicate, aside from the same MDIE, a same SSID as the source access point, and eventually HESSID when provided.

Further, with knowledge of the target access point MAC address, the UE 1201 is able to calculate a new PMK-R1 that is used for the derivation of the working cyphering keys for ciphering communications to the target access point 1204. Subsequent to making the determination to perform the handover operation, the UE proceeds to 12001.

During 12001, the UE 1201 signals the source access point 1203. This signalling may be performed while the UE 1201 is still connected to the source access point 1203 for receiving services (e.g., while still being connected to the source access point 1203 for exchange of user data).

The signalling of 12001 may comprise a FT Action Request message that comprises an identifier of the target access point 1204 (e.g., the target access point's MAC address) and the Fast Transition Information Element (FTIE1). This signalling may cause the source access point 1203 to prepare for a fast transition of the UE 1201 from the source access point 1203 to the target access point 1204 through preestablishment of the required keying material.

During 12002, the source access point 1203 signals the source TNGF 1205. This signalling of 12002 may comprise information comprised in the signalling of 12001. This signalling of 12002 may cause the source TNGF to determine whether the target access point 1204 belongs to the source TNGF 1205 (and may thus use a standard Fast Transition procedure between two access points served by the same TNGF), or whether the target access point 1204 belongs to another TNGF that the TNGF 1205 (and therefore the desired transition addresses another TNAN served by another TNGF).

During 12003, the source TNGF determines (e.g., identifies) the target TNGF via the target access point identifier (e.g., via the target MAC address). In the present case, the source TNGF is also the target TNGF (i.e. the TNGF that manages access to the 5GC for the target access point 1204).

For example, the source TNGF 1205 may determine the target TGNF using a preconfigured (in the source TNGF 1205) list of access points that serve neighbouring TNGFs neighbouring to the source TNGF 1205.

As another example, the source TNGF may use a common database and/or registry (e.g., an NRF) for performing the determination. As one example, each TNGF (including the target TNGF) may register its address (e.g., its Xn address) onto an NRF with a respective associated list of MAC addresses of access point that TNGF serves. This registration may be performed using, for example, an Nnrf_NFManagement_NFRegister service operation (which is defined in 3GPP TS 23.502). Such a determination may be performed by the source TNGF discovering the target TNGF by performing, for example, an Nnrf_NFDiscovery_Request operation defined in 3GPP TS 23.502, providing the target access point MAC address as input parameter

During 12004, the source TNGF 1205 signals the target access point 1204. This signalling may inform the target access point 1204 about the upcoming handover. This signaling may comprise PMK-R1. This signalling may comprise an identifier of the UE 1201 being handed over. This signalling may comprise respective identifiers (e.g., respective MAC identifiers) of the target access point and of the source access point 1203. The signalling of 12004 may be performed using an FT_Indication message.

With the information received from the source TNGF 1205 during 12004, the target access point uses the received PMK-R1 to derive working keys and content of a resulting FTIE (labelled FTIE2 herein). This FTIE2 is signalled from the target access point 1204 to the source TNGF 1205 during 12005. The signalling of 12005 may comprise the identifier of the UE 1201 and the respective identifiers of the target access point and the source access point. The signalling of 12005 may be provided via an FT-Confirmation message.

During 12006, the source TGNF 1205 signals the source access point 1203. This signalling may comprise FTIE2. This signalling may comprise an identifier of the UE. This signalling may comprise the respective identifiers of the source access point and the target access point.

During 12007, the source access point 1203 signals the UE 1201. This signalling may comprise a response to the signalling of the signalling of 12001. This signalling may comprise an FT action response service operation. This signalling may be provided to the UE 1201 over the air when the UE is still able to perform user data transmission over the source access point towards the 5GC.

Having received the necessary preparatory information to execute the final step of fast transition, during 12008, the UE 1201 adjusts its radio parameters for transmission and/or reception, and issues an IEEE 802.11 Reassociation Request message to the target access point 1204.

During 12009, the target access point 1204 responds to the signalling of 12008. This response may be performed based on (e.g., using) the information already available at the target access point. This means that the target access point 1204 may immediately respond to the request of 12008 with a corresponding IEEE 802 Reassociation Response message to conclude the transition and enable the UE to continue exchanging user data with the 5GC via the target access node.

During 12010, which may be performed simultaneously with or in series to the signalling of 12009, the target access point 1204 signals the source TGNF 1205. This signalling of 12010 may indicate that an FT procedure has been successfully completed between the target access point 1204 and the UE 1201. This signalling of 12010 may comprise an identifier of the UE 1201. This signalling of 12010 may comprise respective identifiers of the source access point 1203 and the target access point 1204.

During 12011, the source TNGF 1205 and the UE 1201 exchange signalling. This signalling relates to establishing an IPSec endpoint at target TNGF. For example, this signalling may cause a previous IP connection of the UE 1201 to be continued using a previous IP context used by the UE 1201 with the source TNGF 1205. Further, this signalling may cause an IPSec tunnel usage between the UE 1201 and the source TNGF 1205 that is still based on use of the PMK-R0 security association.

As the TNGF has not changed from the source TNGF to another TNGF, entities within the 5GC are not informed of this change of access point.

Examples involving FT over the air will now be described.

During the case of FT over the Air, the UE terminates sending user data to the serving access point and initiates Fast Transition with an authentication message directly to the target access point. As the target access point may belong to a different WLAN access zone belonging to another TNGF, the target TNGF determines the serving TNGF through the information provided by the UE in its Authentication Request. As the serving TNGF has the key holder for the PMK-R0, the serving TGNF is requested to forward the PMK-R0 to the target TNGF to allow the target TNGF to generate and to allocate a PMK-R1 at the target access point. The target access point processes the information comprised in the FTIE and respond back directly to the UE through an Authentication Response message to proceed the re-keying procedure.

After successful completion of the WLAN Fast Transition including the relocation of the IPsec tunnel across different access zones, the PMK-R0 is removed at the source TNGF so that PMK-R0 continues to exist only at the target TNGF.

Some examples of signalling that may be performed for architectures and deployment options involving FT over the air are now described with reference to FIGS. 13 to 15.

FIG. 13 illustrates operations relating to signalling for support of WLAN Fast Transition over the Air across multiple TNGFs through the Xn interface.

illustrates signalling that may be performed between a UE 1301, a gNB 1302, a source access point 1303, a target access point 1304, a source TNGF 1305, a target TNGF 1306, an AMF 1307 and a 5GC network function 1308 (e.g., an SMF and/or a UPF). It is assumed that the UE is configured with PMK-R0 and at least one PMK-R1 derived from PMK-R0, the source access point is configured with the at least one PMK-R1, and the source TNGF is configured with PMK-R0.

Prior to performing any handover, the UE performs WLAN measurements for determining whether a handover is to be requested from the source access point 1303 to the target access point 1304. This determination may be further performed based on neighborhood information delivered to the UE 1301 from the source access point that provides information for discovering target access point 1304.

This means that when UE determines, based on the UE's preconfigured internal policies, that the current WLAN radio link does not provide the required level of service, the UE 1301 scans the environment and selects a target access point that exposes the same Mobility Domain Information Element (MDIE) as the source access point for the most seamless handover to maintain the required quality of service. The chosen target access point may indicate, aside from the same MDIE, a same SSID as the source access point, and eventually HESSID when provided.

Further, with knowledge of the target access point MAC address, the UE 1301 is able to calculate a new PMK-R1 that is used for the derivation of the working cyphering keys for ciphering communications to the target access point 1304. Subsequent to making the determination to perform the handover operation, the UE proceeds to 13001.

During 13001, the UE 1301 signals the target access point 1304. This signalling may be performed while the UE 1301 is still connected to the source access point 1303 for receiving services (e.g., while still being connected to the source access point 1303 for exchange of user data).

The signalling of 13001 may comprise a Fast Transition Information Element (FTIE1). The FTIE1 may comprise an identifier of the UE and of the source access point 1303, and cause the target access point 1304 to prepare for a fast transition of the UE 1301 from the source access point 1303 to the target access point 1304 through preestablishment of the required keying material. The fast transition to the target access point may be initiated with the establishment of the keying material through piggybacking the 4-way-handshake onto the Authentication and Reassociation messaging.

During 13002, the target access point 1304 signals the target TNGF 1306. This signalling of 13002 may comprise information comprised in the signalling of 13001 (e.g., respective identifiers (such as MAC addresses) of the UE 1301, the source access point 1303 and the target access point 1304). This signalling of 13002 may cause the target TNGF to determine whether the source access point 1303 belongs to the target TNGF 1305 (and may thus use a standard Fast Transition procedure between two access points served by the same TNGF), or whether the source access point 1303 belongs to another TNGF than the target TNGF 1305 (and therefore the desired transition addresses another TNAN served by another TNGF).

The signalling of 13002 may be performed based on (e.g., in response to) the target access point receiving the indication for a FT handover and recognizing that the PMK-R1 is missing. The signalling of 13002 may request the provisioning of the related keying material (PMK-R1).

When the source access point 1303 belongs to another TNGF than the target TNGF (which may be determined by examining the identifier of the target access point provided in the signalling of 13002), the target TNGF 1306 proceeds to 13003.

During 13003, the target TNGF determines (e.g., identifies) the source TNGF 1305 via the source access point identifier (e.g., via the source MAC address). The target TNGF 1306 may use any mechanism for determining the source TNGF.

For example, the target TNGF 1306 may determine the source TGNF 1305 using a preconfigured (in the target TNGF 1306) list of access points that serve neighbouring TNGFs neighbouring to the target TNGF 1306.

As another example, the target TNGF may use a common database and/or registry (e.g., an NRF) for performing the determination. As one example, each TNGF (including the target and source TNGF) may register its address (e.g., its Xn address) onto an NRF with a respective associated list of MAC addresses of access point that TNGF serves. This registration may be performed using, for example, an Nnrf_NFManagement_NFRegister service operation (which is defined in 3GPP TS 23.502). Such a determination may be performed by the source TNGF discovering the target TNGF by performing, for example, an Nnrf_NFDiscovery_Request operation defined in 3GPP TS 23.502, providing the target access point MAC address as input parameter.

During 13004, the target TNGF 1306 signals the source TNGF 1305. This signalling may comprise a request for PMK-R0. This signalling may comprise a UE context request (e.g., an Xn UE context Request that is currently defined 3GPP 38.300 (e.g. clause 9.2.3.2.1)). The signaling may comprise the respective identifiers for the UE, source access point, and target access point. For example, the signalling may comprise respective MAC addresses for the UE, source access point, and target access point. The signalling of 13004 may comprise an address for where the source TNGF may forward downlink traffic not delivered to the UE to the target TNGF 1306 after handover is completed.

During 13005, the source TNGF 1305 stops its IPSec state machine to freeze counters and to allow for a clean transfer of the states to the target TNGF, and responds to the signalling of 13004. This signalling may comprise the requested keying material (PMK-R0). This signalling may comprise IPSec related parameters (for example, SPI, list of SA (Security Association), the traffic filters per SA, the IPSec Sequence Numbers per SA) and the 3GPP keying material received from the 5GC).

During 13006, the target TNGF 1306 initiates enabling of the IPSec endpoint for the UE 1301, and signals the target access point 1304. The signalling of 13006 may comprise a response to the signalling of 13002. The signalling of 13006 may comprise the identifier of the UE (e.g., the UE's MAC address), and a PMK-R1, which was derived by the target TNGF 1306 using the keying material received from the source TNGF during 13005.

With the knowledge of PMK-R1, the target access point 1304 is able to proceed with performing the FT messaging over the air according to IEEE 802.11 specifications without any further interactions with its TNGF. For example, the target access point 1304 determines FTIE2 (as discussed above with reference to FIGS. 10 to 12), and signals an authentication response to the signalling of 13001 during 13007. The signalling of 13007 may comprise an 802.11 Auth Response.

During 13008, the UE 1301 signals the target access point 1304 to initiate the final step of handover through sending a Reassociation Request containing FTIE3 (this may correspond to step 3 of the 4-way-handshake previously described).

During 13009, the WLAN transition concludes through the target access point 1306 responding to the UE's signalling of 13008 with a Reassociation Response comprising FTIE4 of the final step of the 4-way-handshake. In parallel with, or in series to sending the Reassociation Response to the UE during 13009, the target access point informs the target TNGF about the successful handover in 13010 (e.g., using an FT_success message). The signalling of 13010 may comprise respective identifiers (e.g., MAC addresses) for each of the UE, the source access point, and the target access point.

During 13011, the target TNGF 1306 signals the AMF 1307. This signalling may comprise a path switch request for causing data for the UE 1301 to be forwarded to the target TNGF 1306.

During 13012, the 5GC network function 1308 and AMF 1307 exchange signalling for causing a packet data unit (PDU) session for the UE 1301 to be updated to render the target TNGF 1306 as an endpoint for user data for the UE 1301. This may be performed in accordance with 3GPP standards (e.g., in accordance with 3GPP TS 23.502).

During 13013, the UE 1301 and target TNGF 1306 exchange signalling. This signalling relates to establishing an IPSec endpoint at target TNGF. For example, this signalling may cause a previous IP connection of the UE 1301 to be continued using a previous IP context used by the UE 1001 with the source TNGF 1305. Further, this signalling may cause an IPSec tunnel usage between the UE 1301 and the target TNGF 1306 that is still based on use of the PMK-R0 security association.

During 13014, the AMF 1307 signals the target TNGF 1306 to indicate that the path switch request has been successfully completed.

During 13015, the target TNGF 1306 signals the source TNGF 1305 to indicate that the source TNGF 1305 may release any resources currently reserved by the source TNGF 1305 for use for the UE 1301. The source TNGF 1305 may perform that release based on receipt of the signalling of 13015, and respond to the signalling of 13015 during 13016. The signalling of 13016 may comprise an indication that the source TNGF 1305 has released resources currently reserved by the UE 1301, and any user plane traffic for the UE 1301 not previously provided to the target TNGF 1306.

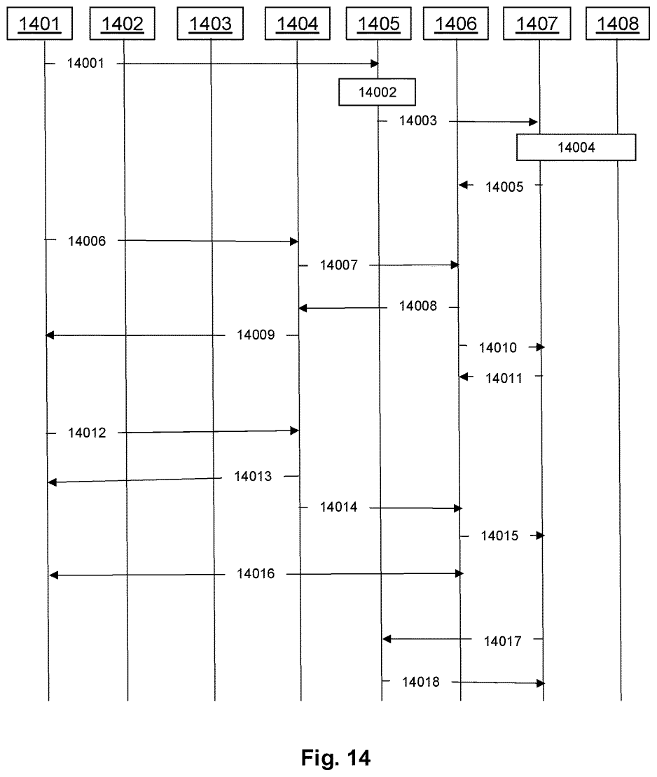

FIG. 14 illustrates another example of signalling that may be performed for WLAN FT over the air. The signalling of FIG. 14 relates to an example of inter-TNGF WLAN Fast Transition over the Air across multiple TNGFs through N2.

FIG. 14 illustrates signalling that may be performed between a UE 1401, a gNB 1402, a source access point 1403, a target access point 1404, a source TNGF 1405, a target TNGF 1406, an AMF 1407 and a 5GC network function 1408 (e.g., an SMF and/or a UPF). It is assumed that the UE is configured with PMK-R0 and at least one PMK-R1 derived from PMK-R0, the source access point is configured with the at least one PMK-R1, and the source TNGF is configured with PMK-R0.

Prior to performing any handover, the UE performs WLAN measurements for determining whether a handover is to be requested from the source access point 1403 to the target access point 1404. This determination may be further performed based on neighborhood information delivered to the UE 1401 from the source access point that provides information for discovering target access point 1404.

This means that when UE determines, based on the UE's preconfigured internal policies, that the current WLAN radio link does not provide the required level of service, the UE 1401 scans the environment and selects a target access point that exposes the same Mobility Domain Information Element (MDIE) as the source access point for the most seamless handover to maintain the required quality of service. The chosen target access point may indicate, aside from the same MDIE, a same SSID as the source access point, and eventually HESSID when provided.

Further, with knowledge of the target access point MAC address, the UE 1401 is able to calculate a new PMK-R1 that is used for the derivation of the working cyphering keys for ciphering communications to the target access point 1404. Subsequent to making the determination to perform the handover operation, the UE proceeds to 14001.

During 14001, the UE 1401 signals the source TNGF 1405. This signalling may be performed while the UE 1401 is still connected to the source access point 1403 for receiving services (e.g., while still being connected to the source access point 1403 for exchange of user data).

The signalling of 14001 may comprise a handover request that comprises an identifier of the target access point 1404 (e.g., the target access point's MAC address and an identifier of the UE 1401 (e.g., the UE's MAC address). This signalling may cause the source TNGF 1405 to prepare for a handover of the UE 1401 from the source access point 1403 to the target access point 1404.

During 14002, the source TNGF 1405 determines whether the target access point 1404 belongs to the source TNGF 1405, or whether the target access point 1404 belongs to another TNGF than the source TNGF 1405. In the present example, the target access point 1401 belongs to the target TNGF 1406.

During 14002, the source TNGF 1405 determines (e.g., identifies) the target TNGF 1406 via the target access point identifier (e.g., via the target MAC address). The source TNGF 1405 may use any mechanism for determining the target TNGF.

For example, the source TNGF 1405 may determine the target TGNF 1406 using a preconfigured (in the source TNGF 1405) list of access points that serve neighbouring TNGFs neighbouring to the source TNGF 1405.

As another example, the source TNGF may use a common database and/or registry (e.g., an NRF) for performing the determination. As one example, each TNGF (including the target TNGF) may registers its address (e.g., its Xn address) onto an NRF with a respective associated list of MAC addresses of access point that TNGF serves. This registration may be performed using, for example, an Nnrf_NFManagement_NFRegister service operation (which is defined in 3GPP TS 23.502). Such a determination may be performed by the source TNGF discovering the target TNGF by performing, for example, an Nnrf_NFDiscovery_Request operation defined in 3GPP TS 23.502, providing the target access point MAC address as input parameter.

When the target access point 1404 belongs to another TNGF than the source TNGF (which may be determined by examining the identifier of the target access point provided in the signalling of 14001) and the target TNGF 1406 has been identified, the source TNGF 1405 proceeds to 14003.

During 14003, the source TNGF 1405 signals the AMF 1407. This signalling may indicate that the UE will be handed over to another TNGF 1406 than the source TNGF 1605. This signalling may comprise the primary key material, PMK-R0. This signalling may comprise an N2 Handover Required service operation.

During 14004, the AMF 1407 and user plane entities 1408 exchange signalling for preparing for handover of the UE from the source TNGF 1405 to the target TNGF 1406. As part of this preparation (which may be largely in accordance with the handover preparation described in 3GPP standards, such as 3GPP TS 23.502 FIG. 4.9.1.3.2-1 steps 1 to 12), PMK-R0 may be exchanged between the AMF 1407 and the 5GC network function 1408.

During 14005, the AMF 1407 signals the target TNGF 1406. This signalling may comprise a handover request for requesting that the UE 1401 be handed over to the target TNGF 1406. This signalling may comprise the primary key material PMK-R0.

During 14006, the UE 1401 signals the target access point 1404. This signalling may be performed while the UE 1401 is still connected to the source access point 1403 for receiving services (e.g., while still being connected to the source access point 1403 for exchange of user data).

The signalling of 14006 may comprise a FT Action Request message that comprises an identifier of the target access point 1404 (e.g., the target access point's MAC address) and the Fast Transition Information Element (FTIE1). The FTIE1 may comprise an identifier of the UE and of the source access point 1403, and cause the target access point 1404 to prepare for a fast transition of the UE 1401 from the source access point 1403 to the target access point 1404 through preestablishment of the required keying material. The fast transition to the target access point may be initiated with the establishment of the keying material through piggybacking the 4-way-handshake onto the Authentication and Reassociation messaging. The signalling of 14006 may comprise an 802.11 Auth Request.

During 14007, the target access point 1404 signals the target TNGF 1406. This signalling of 14007 may comprise information comprised in the signalling of 14006 (e.g., respective identifiers (such as MAC addresses) of the UE 1401, the source access point 1403 and the target access point 1404). This signalling of 14007 may cause the target TNGF to determine whether the source access point 1403 belongs to the target TNGF 1406 (and may thus use a standard Fast Transition procedure between two access points served by the same TNGF), or whether the source access point 1403 belongs to another TNGF than the target TNGF 1406 (and therefore the desired transition addresses another TNAN served by another TNGF).

The signalling of 14007 may be performed based on (e.g., in response to) the target access point receiving the indication for a FT handover and recognizing that the PMK-R1 is missing. The signalling of 14007 may request the provisioning of the related keying material (PMK-R1).

When the source access point 1403 belongs to another TNGF than the target TNGF (which may be determined by examining any identifier of the target access point provided in the signalling of 14007), the target TNGF 1406 proceeds to 14008.

During 14008, the target TNGF 1406 initiates enabling of the IPSec endpoint for the UE 1401, and signals the target access point 1404. The signalling of 14008 may comprise a response to the signalling of 14010. The signalling of 14008 may comprise the identifier of the UE (e.g., the UE's MAC address), and a PMK-R1 that was derived by the target TNGF 1406 using the keying material received from the AMF during 14005.

With the knowledge of PMK-R1, the target access point 1404 is able to proceed the FT messaging over the air according to IEEE 802.11 specifications without any further interactions with its TNGF. For example, the target access point 1404 determines FTIE2 (as discussed above with reference to FIGS. 10 to 13), and signals an authentication response to the signalling of 14006 during 14009. The signalling of 14009 may comprise an 802.11 Auth Response.

During 14010, which may be performed in series or in parallel to the signalling of 14008, the target TNGF 1406 signals the AMF 1407. This signalling may comprise a path switch request for causing data for the UE 1401 to be forwarded to the target TNGF 1406.

During 14011, the 5GC network function 1408 and AMF 1307 exchange signalling for causing a packet data unit (PDU) session for the UE 1401 to be updated to render the target TNGF 1406 as an endpoint for user data for the UE 1401. This may be performed in accordance with 3GPP standards (e.g., in accordance with 3GPP TS 23.502).

During 14012, the UE 1401 signals the target access point 1404 to initiate the final step of handover through sending a Reassociation Request containing FTIE3 (this may correspond to step 3 of the 4-way-handshake previously described).

During 14013, the WLAN transition concludes through the target access point 1404 responding to the UE's signalling of 14013 with a Reassociation Response comprising FTIE4 of the final step of the 4-way-handshake. Together with sending the Reassociation Response to the UE, the target access point informs the target TNGF about the successful handover in 14014 (e.g., using an FT_success message). The signalling of 14014 may comprise respective identifiers (e.g., MAC addresses) for each of the UE, the source access point, and the target access point.

During 14016, the UE 1401 and target TNGF 1406 exchange signalling. This signalling relates to establishing an IPSec endpoint at target TNGF. For example, this signalling may cause a previous IP connection of the UE 1401 to be continued using a previous IP context used by the UE 1401 with the source TNGF 1405. Further, this signalling may cause an IPSec tunnel usage between the UE 1401 and the target TNGF 1406 that is still based on use of the PMK-R0 security association.

During 14017, the AMF 1407 signals the target TNGF 1406 to indicate that the path switch request has been successfully completed.

During 14018, the target TNGF 1406 signals the source TNGF 1405 to indicate that the source TNGF 1405 may release any resources currently reserved by the source TNGF 1405 for use for the UE 1401. The source TNGF 1405 may perform that release based on receipt of the signalling of 14018, and respond during 14021 to confirm UE context release.

FIG. 15 relates to another example of signaling that may be performed for FT over the air. The example of FIG. 15 relates to providing support for of WLAN Fast Transition over the Air within a TNAN served by a single TNGF.

FIG. 15 illustrates signalling that may be performed between a UE 1501, a gNB 1502, a source access point 1103, a target access point 1504, and a source TNGF 1505. It is assumed that the UE is configured with PMK-R0 and at least one PMK-R1 derived from PMK-R0, and the source TNGF is configured with PMK-R0.

Prior to performing any handover, the UE performs WLAN measurements for determining whether a handover is to be requested from the source access point 1503 to the target access point 1504. This determination may be further performed based on neighborhood information delivered to the UE 1501 from the source access point that provides information for discovering target access point 1504.

This means that when UE determines, based on the UE's preconfigured internal policies, that the current WLAN radio link does not provide the required level of service, the UE 1501 scans the environment and selects a target access point that exposes the same Mobility Domain Information Element (MDIE) as the source access point for the most seamless handover to maintain the required quality of service. The chosen target access point may indicate, aside from the same MDIE, a same SSID as the source access point, and eventually HESSID when provided.

Further, with knowledge of the target access point MAC address, the UE 1501 is able to calculate a new PMK-R1 that is used for the derivation of the working cyphering keys for ciphering communications to the target access point 1504. Subsequent to making the determination to perform the handover operation, the UE proceeds to 15001.

During 15001, the UE 1501 signals the target access point 1504. This signalling may be performed while the UE 1501 is still connected to the source access point 1503 for receiving services (e.g., while still being connected to the source access point 1503 for exchange of user data).

The signalling of 15001 may comprise a Fast Transition Information Element (FTIE1). This signalling may cause the target access point 1504 to prepare for a fast transition of the UE 1501 from the source access point 1503 to the target access point 1504 through preestablishment of the required keying material.

During 15002, the target access point 1504 signals the source TNGF 1505. This signalling of 15002 may comprise information comprised in the signalling of 15001 (e.g., respective identifiers (such as MAC addresses) of the UE 1501, the source access point 1503 and the target access point 1504). This signalling of 15002 may cause the TNGF to determine whether the source access point 1503 and/or target access point 1504 belongs to the TNGF 1505 (and may thus use a standard Fast Transition procedure between two access points served by the same TNGF), or whether the source access point 1503 belongs to another TNGF than the TNGF 1505 (and therefore the desired transition addresses another TNAN served by another TNGF).

The signalling of 15002 may be performed based on (e.g., in response to) the target access point receiving the indication for a FT handover and recognizing that the PMK-R1 is missing. The signalling of 15002 may request the provisioning of the related keying material (PMK-R1). The signalling of 15002 may comprise an FT_Request service operation.

During 15003, the source TNGF determines (e.g., identifies) the target TNGF via the target access point identifier (e.g., via the target MAC address). In the present case, the source TNGF is also the target TNGF (i.e., the TNGF that manages access to the 5GC for the target access point 1504).

For example, the source TNGF 1505 may determine the target TGNF using a preconfigured (in the source TNGF 1505) list of access points that serve neighbouring TNGFs neighbouring to the source TNGF 1505.

As another example, the source TNGF may use a common database and/or registry (e.g., an NRF) for performing the determination. As one example, each TNGF (including the target TNGF) may register its address (e.g., its Xn address) onto an NRF with a respective associated list of MAC addresses of access point that TNGF serves. This registration may be performed using, for example, an Nnrf_NFManagement_NFRegister service operation (which is defined in 3GPP TS 23.502). Such a determination may be performed by the source TNGF discovering the target TNGF by performing, for example, an Nnrf_NFDiscovery_Request operation defined in 3GPP TS 23.502, providing the target access point MAC address as input parameter

During 15003, the source TNGF 1505 determines PMK-R0 using the source access point identifier and UE identifier received during 15002, and derives PMK-R1 for use by the target access point in generating the working ciphering keys.

During 15004, the source TNGF 1505 signals the target access point 1504. This signalling may comprise PMK-R1. This signalling may comprise an identifier of the UE. This signalling may comprise the respective identifiers of the source access point 1503 and the target access point 1504. This signalling may comprise an FT action response service operation.

During 15005, the target access point 1504 signals the UE 1501. This signalling may comprise a response to the signalling of the signalling of 15001. This signalling may be provided to the UE 1501 over the air when the UE is still able to perform user data transmission over the source access point towards the 5GC. This signalling may comprise FTIE2. This signalling may comprise an 802.11 Auth Response service operation.

Having received the necessary preparatory information to execute the final step of fast transition (e.g., FTIE2), during 15005, the UE 1501 adjusts its radio parameters for transmission and/or reception, and issues an IEEE 802.11 Reassociation Request message to the target access point 1504 during 15006. The signalling of 15006 may comprise FTIE3.

During 15007, the target access point 1504 responds to the signalling of 15006. This response may be performed based on (e.g., using) the information already available at the target access point. This means that the target access point 1504 may immediately respond to the request of 15006 with a corresponding IEEE 802 Reassociation Response message to conclude the transition and enable the UE to continue exchanging user data with the 5GC via the target access node. The signalling of 15006 may comprise FTIE4.

During 15008, which may be performed in parallel with the signalling of 15007 or after the signalling of 15007, the target access point 1504 signals the source TNGF 1505 to indicate that a handover operation has been completed between the target access point and the UE 1501.

During 15009, the TNGF 1505 and the UE 1501 exchange signalling. This signalling relates to establishing an IPSec endpoint at target TNGF. For example, this signalling may cause a previous IP connection of the UE 1501 to be continued using a previous IP context used by the UE 1501 with the source TNGF 1505. Further, this signalling may cause an IPSec tunnel usage between the UE 1501 and the TNGF 1505 that is still based on use of the PMK-R0 security association.

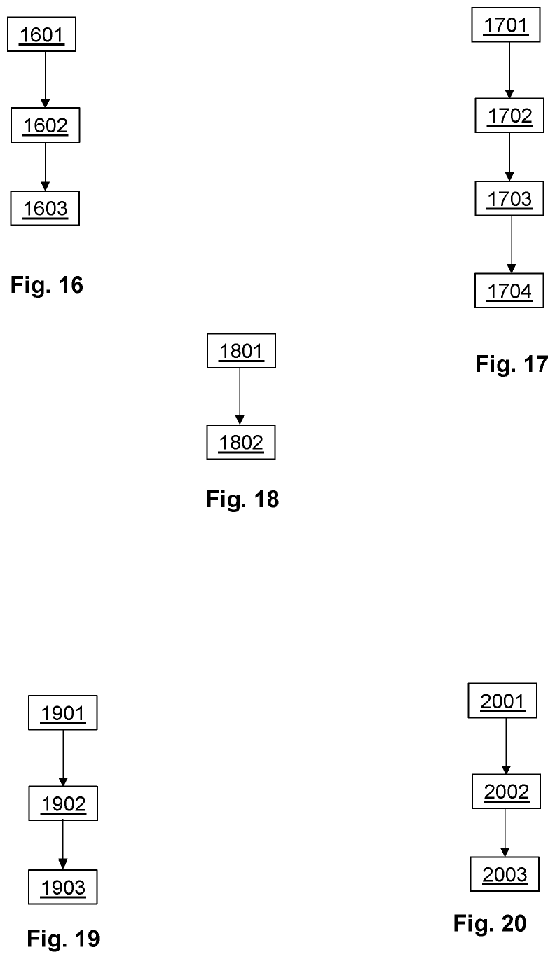

FIGS. 16 to 20 illustrate features of the above-described examples. It is therefore understood that features mentioned above may have a functional equivalence with features mentioned below. It is further understood that the above-mentioned examples may provide further features that complement the features mentioned below in some implementations.

FIG. 16 illustrates features that may be performed by a source interworking function interfacing between a source access point and a core network. The source interworking function may comprise an N2IWF. The source interworking function may comprise a TNGF.

During 1601, the source interworking function receives, an indication that a user equipment is to be handed over from the source access point to a target access point.

During 1602, the source interworking function makes a first determination that determines whether the source interworking function interfaces between the target access point and the core network.

During 1603, the source interworking function determines, in dependence on (e.g., based on) said first determination, keying material for use in encrypting communications between the target access point and the user equipment.

When the first determination determines that the source interworking function interfaces between the target access point and the core network, the determining keying material may comprise: identifying a primary pairwise master key (e.g., PMK-R0) used to derive a source secondary pairwise master key (e.g., PMK-R1) for encrypting communications between the source access point and the user equipment; and using the primary pairwise master key to derive a target secondary pairwise master key for encrypting communications between the target access point and the user equipment. This example may therefore correspond to cases in which the source interworking function is also a target interworking function.

When the first determination determines that the source interworking function does not interface between the target access point and the core network, the determining keying material may comprise: identifying a primary pairwise master key (e.g., PMK-R0) used to derive a source secondary pairwise master key (e.g., PMK-R1 for the source) for encrypting communications between the source access point and the user equipment; identifying a target interworking function that interfaces between the target access point and the core network; and providing the primary pairwise master key to the target interworking function. In this example (in which the source interworking function is not a target interworking function), the source interworking function does not derive the target secondary pairwise master key for encrypting communications between the target access point and the user equipment. The target interworking function may comprise an N2IWF. The target interworking function may comprise a TNGF.

The indication may be received from the source access point in a request for a fast handover (FT_req). The request for the fast handover may comprise a first query (e.g., FTIE1). The first query may comprise a first step in a four step handshaking operation for completing the fast handover. The source interworking function may provide the first query to the target interworking function. This providing may be performed via an Xn interface (e.g., this providing may be performed using an interface between the source and target interworking functions). For example, the providing may be performed using a UE context forward message.

The source interworking function may receive, from the target interworking function, a first response (e.g., FTIE2) to the first query. The first response may comprise a second step in the four step handshaking operation. This receiving may be performed via an Xn interface (e.g., this receiving may be performed using an interface between the source and target interworking functions). For example, the receiving may be performed using a UE context forward message.

The source interworking function may forward the first response to the source access point.

As another example, when the first determination determines that the source interworking function does not interface between the target access point and the core network, the determining keying material may comprise: identifying a primary pairwise master key (e.g., PMK-R0) used to derive a source secondary pairwise master key (e.g., PMK-R1) for encrypting communications between the source access point and the user equipment; and providing the primary pairwise master key to an access and mobility function in the core network.

When the indication is received from the source access point in a request for a fast handover, the request for the fast handover may comprise a first query, and the source interworking function may: provide the first query to the access and mobility function; receive, from the access and mobility function, a first response to the first query; and forward the first response to the source access point. As mentioned above, the first query may comprise FTIE1, and the first response may comprise FTIE2. The first query may comprise a first step in a four step handshaking operation for completing the fast handover. The providing may be performed via an N2 interface (e.g., this providing may be performed using respective interfaces between an access and mobility function and the source and target interworking functions). For example, this providing may be performed using an N2 handover required message. The receiving may be performed via an N2 interface (e.g., this receiving may be performed using an interface between the access and mobility function and the source interworking function). For example, this receiving may be performed using an N2 handover command message.

In the above examples relating to the source and target interworking functions being comprised in separate functions, subsequent to the user equipment being handed over from the source access point to the target access point, the source interworking function may receive an instruction to remove the primary pairwise master key, and remove the primary pairwise master key from local storage. The instruction to remove the primary pairwise master key may be comprised in a user equipment context release message. The UE context release message may be received from a target interworking function (e.g., over an Xn interface). The source interworking function may disable an Internet Protocol Security endpoint for the user equipment in response to receiving said instruction to remove the primary pairwise master key.

FIG. 17 illustrates operations that may be performed by a target interworking function interfacing between a target access point and a core network. The target interworking function may comprise an N2IWF. The target interworking function may comprise a TNGF. The target interworking function may be the target interworking function mentioned above in respect of FIG. 16.

During 1701, the target interworking function may receive, an indication that a user equipment is to be handed over from a source access point to the target access point.

During 1702, the target interworking function may obtain keying material comprising a primary pairwise master key (e.g., PMK-R0) that was used to derive a source secondary pairwise master key for encrypting communications between the source access point and the user equipment.

During 1703, the target interworking function may use the primary pairwise master key to derive a target secondary pairwise master key (e.g., PMK-R1) for encrypting communications between the target access point and the user equipment.

During 1704, the target interworking function may cause the target secondary pairwise master key to be provided to the target access point.

When the indication is received from a target access point, the obtaining the primary pairwise master key may comprise: making a first determination that determines that the target interworking function is also a source interworking function that interfaces between the source access point and the core network; and identifying the primary pairwise master key as a key previously used by the target interworking function to derive a source secondary pairwise master key for encrypting communications between the source access point and the user equipment.

When the indication is received from a target access point, the obtaining the primary pairwise master key may comprise: making a first determination that determines that the target interworking function does not interface between the source access point and the core network; identifying a source interworking function that interfaces between the source access point and the core network; signalling a request for the primary pairwise master key as to at least one of an access and mobility function associated with the core network; and receiving the primary pairwise master key in response to said request. The source interworking function may be as described above in relation to FIG. 16. The signalling the request for the primary pairwise master key may comprise signalling the request to the source interworking function using an Xn interface (e.g., using a UE context request). The signalling the request for the primary pairwise master key may comprise signalling the request to the source interworking function via an AMF (e.g., using an N2 interface). The receiving the primary pairwise key may comprise receiving the key from the source interworking function using an Xn interface (e.g., using a UE context message). The receiving the primary pairwise key may comprise receiving the key from the source interworking function via an AMF (e.g., using an N2 interface).

The indication may be received at the target interworking function from the target access point in a request for a fast handover. In such cases, the request for the fast handover may comprise a first query (e.g., FTIE1, which may be step one of a four step handshake, as discussed above). The target interworking function may provide the target secondary pairwise master key to the target access point as a response to (e.g., based on) receiving the indication. Further, in this example, the receiving the primary pairwise key from the source interworking function may comprise receiving the primary pairwise key as part of a first fast transition information element comprised in an Xn user equipment context message.

The indication may be received from at least one of an access and mobility function associated with a core network and a source interworking function that interfaces between the source access point and the core network. When the indication is received from a source interworking function, the indication may be received via an X2 interface (e.g., via a UE context message). When the indication is received from an access and mobility function (e.g., via a handover request), the indication may be received via an N2 interface. The obtaining the primary pairwise master key may comprise receiving the primary pairwise master key with said indication.

In all of the above examples, subsequent to the user equipment being handed over from the source access point to the target access point (e.g., when the user equipment has completed the fast transition procedure), the target interworking function may signal an instruction to a source interworking function that interfaces between the source access point and the core network to remove the primary pairwise master key from the source interworking function. It is understood that the AMF may signal this instruction when the user equipment has completed the fast transition procedure (e.g., either autonomously or in response to an indication to this effect from the target interworking function).

In all of the above examples, subsequent to causing the target secondary pairwise master key to be provided to the target access point, the target interworking function may cause an Internet Protocol Security endpoint to be established for traffic of the user equipment.

FIG. 18 illustrates operations that may be performed by an access and mobility function associated with a core network. This AMF may be the AMF discussed above in relation to at least one of FIGS. 16 and 17.

During 1801, the AMF receives, from a source interworking function that interfaces between a source access point and the core network, keying material comprising a primary pairwise master key (PMK-R0) that was used to derive a source secondary pairwise master key for encrypting communications between a source access point and the user equipment. The source interworking function may be as described above in relation to at least one of FIGS. 16 and 17. This receiving may be performed over a first N2 interface between the AMF and the source interworking function.

During 1802, the AMF provides the keying material to a target interworking function that interfaces between a target access point and the core network. The target interworking function may be as described above in relation to at least one of FIGS. 16 and 17. This provision may be performed over a second N2 interface between the AMF and the target interworking function.

The AMF may receive, from the target interworking function, a request for the keying material (e.g., via a handover request signalled over the second N2 interface). The AMF may signal the request for the keying material to the source interworking function. The AMF may receive the keying material in response to said signalling.

FIG. 19 illustrates operations that may be performed by an access point. The access point may be a source access point or a target access point, as described above in relation to any of FIGS. 16 to 18.

During 1901, the access point provides, to an interworking function interfacing between the access point and a core network, a request for a fast transition to be performed in respect of a user equipment to be handed over from or to the access point, the request comprising a first fast transition information element (e.g., FTIE1) relating to a primary keying material. The interworking function may be a source interworking function as described in relation to any of FIGS. 16 to 18. The interworking function may be a target interworking function as described in relation to any of FIGS. 16 to 18.

During 1902, the access point receives, from the interworking function, a response to said request, the response comprising a second fast transition information element relating to secondary keying material derived from the primary keying material.

During 1903, the access point provides the second fast transition information element (e.g., FTIE2) to the user equipment as part of a fast transition procedure.

FIG. 20 illustrates operations that may be performed by a target access point. The target access point may be as described above in relation to any of FIGS. 16 to 19.

During 2001, the target access point receives, from an interworking function interfacing between the target access point and a core network, a request indicating that a user equipment is to be handed over from a source access point to the target access point using a fast transition procedure, the request comprising a first fast transition information element (e.g., FTIE1) and secondary keying material (e.g., PMK-R1 generated by the interworking function).

During 2002, the target access point uses the secondary keying material and the first fast transition information to generate a second fast transition information element (e.g., FTIE2) that functions as a response to the first fast transition information element for enabling the fast transition procedure to proceed.

During 2003, the target access point signals the second fast transition element to the interworking function.

In both of the above examples of FIGS. 19 and 20, the access point may complete the fast transition procedure with the user equipment, and signal, to the interworking function, an indication that the fast transition procedure has been successfully completed, the indication comprising respective identifiers of the user equipment and the access point.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

As provided herein, various aspects are described in the detailed description of examples and in the claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIG. 16 and/or FIG. 17 and/or FIG. 18, and/or FIG. 19, and/or FIG. 20, and/or otherwise described previously, may represent program steps, or interconnected logic circuits, blocks and functions, or a combination of program steps and logic circuits, blocks and functions. The software may be stored on such physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

1-35. (canceled)

36. An apparatus comprising: at least one processor; and at least one memory storing instructions that, when executed by the at least one processor, cause the apparatus at least to perform:
receiving, an indication that a user equipment is to be handed over from the source access point to a target access point;
making a first determination that determines whether the source interworking function interfaces between the target access point and the core network; and
determining, in dependence on said first determination, keying material for use in encrypting communications between the target access point and the user equipment.

37. The apparatus of claim 36, wherein the first determination determines that the source interworking function interfaces between the target access point and the core network, and wherein the determining keying material comprises:
identifying a primary pairwise master key used to derive a source secondary pairwise master key for encrypting communications between the source access point and the user equipment; and
using the primary pairwise master key to derive a target secondary pairwise master key for encrypting communications between the target access point and the user equipment.

38. The apparatus of claim 36, wherein the first determination determines that the source interworking function does not interface between the target access point and the core network, and wherein the determining keying material comprises:
identifying a primary pairwise master key used to derive a source secondary pairwise master key for encrypting communications between the source access point and the user equipment;
identifying a target interworking function that interfaces between the target access point and the core network; and
providing the primary pairwise master key to the target interworking function.

39. The apparatus of claim 38, wherein the indication is received from the source access point in a request for a fast handover, the request for the fast handover comprising a first query, wherein the apparatus is further caused to perform:
providing the first query to the target interworking function;
receiving, from the target interworking function, a first response to the first query; and
forwarding the first response to the source access point.

40. The apparatus of claim 39, wherein the providing the primary pairwise key to the target interworking function comprises providing the primary pairwise key as part of a first fast transition information element comprised in an Xn user equipment context forward service operation, and wherein the receiving the first response to the first query comprises receiving a second fast transition information element comprised in an Xn user equipment context forward service operation.

41. The apparatus of claim 36, wherein the first determination determines that the source interworking function does not interface between the target access point and the core network, and wherein the determining keying material comprises:
identifying a primary pairwise master key used to derive a source secondary pairwise master key for encrypting communications between the source access point and the user equipment; and
providing the primary pairwise master key to an access and mobility function in the core network.

42. The apparatus of claim 41, wherein the indication is received from the source access point in a request for a fast handover, the request for the fast handover comprising a first query, wherein the apparatus is further caused to perform:
providing the first query to the access and mobility function;
receiving, from the access and mobility function, a first response to the first query; and
forwarding the first response to the source access point.

43. The apparatus of claim 42, wherein the providing the primary pairwise key to the access and mobility function comprises providing the primary pairwise key as part of a first fast transition information element comprised in an N2 handover required service operation, and wherein the receiving the first response to the first query comprises receiving a second fast transition information element comprised in an N2 handover command service operation.

44. An apparatus comprising: at least one processor; and at least one memory storing instructions that, when executed by the at least one processor, cause the apparatus at least to perform:
receiving, an indication that a user equipment is to be handed over from a source access point to the target access point;
obtaining keying material comprising a primary pairwise master key that was used to derive a source secondary pairwise master key for encrypting communications between the source access point and the user equipment;
using the primary pairwise master key to derive a target secondary pairwise master key for encrypting communications between the target access point and the user equipment; and
causing the target secondary pairwise master key to be provided to the target access point.

45. The apparatus of claim 44, wherein the indication is received from a target access point, and wherein the obtaining the primary pairwise master key comprises:
making a first determination that determines that the target interworking function is also a source interworking function that interfaces between the source access point and the core network; and
identifying the primary pairwise master key as a key previously used by the target interworking function to derive a source secondary pairwise master key for encrypting communications between the source access point and the user equipment.

46. The apparatus of claim 34, wherein the indication is received from a target access point, and wherein the obtaining the primary pairwise master key comprises:
making a first determination that determines that the target interworking function does not interface between the source access point and the core network;
identifying a source interworking function that interfaces between the source access point and the core network;
signalling a request for the primary pairwise master key as to at least one of an access and mobility function associated with the core network; and
receiving the primary pairwise master key in response to said request.

47. The apparatus of claim 44, wherein the indication is received from the target access point in a request for a fast handover, the request for the fast handover comprising a first query, wherein the apparatus is further caused to perform:
providing the target secondary pairwise master key to the target access point as a response to receiving the indication.

48. The apparatus of claim 47, wherein the receiving the primary pairwise key from the source interworking function comprises receiving the primary pairwise key as part of a first fast transition information element comprised in an Xn user equipment context service operation.

49. The apparatus of claim 44, wherein the indication is received from at least one of an access and mobility function associated with a core network and a source interworking function that interfaces between the source access point and the core network, and wherein the obtaining the primary pairwise master key comprises: receiving the primary pairwise master key with said indication.

50. An apparatus comprising: at least one processor; and at least one memory storing instructions that, when executed by the at least one processor, cause the apparatus at least to perform:
receiving, from a source interworking function that interfaces between a source access point and the core network, keying material comprising a primary pairwise master key that was used to derive a source secondary pairwise master key for encrypting communications between a source access point and the user equipment; and
providing the keying material to a target interworking function that interfaces between a target access point and the core network.

51. The apparatus of claim 50, wherein the apparatus is further caused to perform:
receiving, from the target interworking function, a request for the keying material;
signalling the request for the keying material to the source interworking function; and
receiving the keying material in response to said signalling.
